(19) United States
(12) Patent Application Publication
(10) Pub. No.: US 2015/0166403 A1
(43) Pub. Date: Jun. 18, 2015

(54) GLASS FOR CHEMICAL STRENGTHENING AND CHEMICAL STRENGTHENED GLASS, AND MANUFACTURING METHOD OF GLASS FOR CHEMICAL STRENGTHENING

(71) Applicant: Asahi Glass Company, Limited, Tokyo (JP)

(72) Inventor: Hiroyuki YAMAMOTO, Shizuoka-ken (JP)

(73) Assignee: Asahi Glass Company, Limited, Tokyo (JP)

(21) Appl. No.: 14/633,976

(22) Filed: Feb. 27, 2015

Related U.S. Application Data
(63) Continuation of application No. PCT/JP2013/074636, filed on Sep. 12, 2013.

(30) Foreign Application Priority Data
Sep. 14, 2012 (JP) 2012-203597

(51) Int. Cl. C03C 3/095; C03C 3/083; C03C 21/00; C03C 3/087; C03C 4/18; C03C 4/02; C03C 3/093; C03C 3/085

(52) U.S. Cl. CPC C03C 3/095; C03C 3/093; C03C 3/083; C03C 3/085; C03C 3/087; C03C 4/18; C03C 4/02; C03C 21/002; C03C 2204/00

(57) ABSTRACT

There is provided a glass for chemical strengthening having a gray-based color tone and excelling in characteristics preferred for the purposes of housing or decoration of an electronic device, that is, bubble quality, strength, and light transmittance characteristics. A glass for chemical strengthening contains, in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (where R represents Mg, Ca, Sr, Ba, or Zn), 0.01% to 0.2% of Co₃O₄, 0.05% to 1% of NiO, and 0.005% to 3% of Fe₂O₃.

### CROSS-REFERENCE TO RELATED APPLICATIONS

This application is a continuation of prior International Application No. PCT/JP2013/074636, filed on Sep. 12, 2013 which is based upon and claims the benefit of priority from Japanese Patent Application No. 2012-203597 filed on Sep. 14, 2012; the entire contents of all of which are incorporated herein by reference.

### FIELD

The present invention relates to a glass for chemical strengthening and a chemical strengthened glass used for a housing or decoration of an electronic device such as, for example, a communication device or an information device which are portably usable, and to a manufacturing method of a glass for chemical strengthening. In this description, the “glass for chemical strengthening” refers to a glass on whose surface a compressive stress layer can be formed by chemical strengthening and to a glass before undergoing the chemical strengthening. Further, the “chemical strengthened glass” refers to a glass having undergone the chemical strengthening and having a compressive stress layer formed on its surface by the chemical strengthening.

### BACKGROUND

As a housing or decoration of an electronic device such as a portable phone, an appropriate material is selected and used from materials such as resin and metal in consideration of various factors such as decorativeness, scratch resistance, workability, and cost.

In recent years, there have been attempts to use, as a material for housing, a glass that has not been used hitherto. According to Patent Reference 1 (JP-A 2009-61730 (KOKAI)), by forming the housing itself from a glass in an electronic device such as a portable phone, it is possible to exhibit a unique decorative effect with transparency.

The housing or decoration of an electronic device for portable use such as a portable phone is required to have high strength in consideration of breakage by an impact of dropping when in use or contact scratches due to long-term use.

As a method to increase strength of the glass, a method of forming a compressive stress layer on a glass surface is generally known. Representative methods to form the compressive stress layer on a glass surface are an air-cooling tempering method (physical tempering method) and a chemical strengthening method. The air-cooling tempering method (physical tempering method) is performed by rapidly cooling by air cooling or the like a glass plate surface heated to a temperature near a softening point. On the other hand, the chemical strengthening method is to replace alkali metal ions (typically, Li ions, Na ions) having a smaller ion radius existing on the glass plate surface with alkali ions (typically, Na ions or K ions for Li ions, or K ions for Na ions) having a larger ion radius by ion exchange at temperatures lower than or equal to a glass transition point.

For example, in general, the glass for decoration as described above is often used with a thickness of 2 mm or less. When the air-cooling tempering method is employed for such a thin glass plate, it is difficult to assure a temperature difference between the surface and the inside, and hence it is difficult to form the compressive stress layer. Thus, in the glass after being tempered, the intended high strength characteristic cannot be obtained. Further, in the air-cooling tempering, due to variation in cooling temperature, there is a great concern that the flatness of the glass plate is impaired. The concern that the flatness is impaired is large in a thin glass plate in particular, and there is a possibility of impairing texture aimed by the present invention. From these points, it is preferred that the glass plate be strengthened by the latter chemical strengthening method.

Further, in the housing or decoration of an electronic device such as a portable phone, a glass having a dark color tone such as black or gray is widely used which does not strongly emphasize the presence of the device itself, and by which firmness and luxuriousness can be obtained simultaneously. Among others, a gray-based color tone gives a soft impression and makes a stain due to an extraneous matter on the surface less noticeable, and thus is widely applied to a housing or the like of an electronic device.

A glass described in Patent Reference 2 (JP-B S45-16112 (KOKOKU)) has been known as a glass that can be chemically strengthened and exhibits a black color. The glass described in Patent Reference 2 is an aluminosilicate glass containing a high concentration of iron oxide.

### SUMMARY

In the example disclosed in above Patent Reference 2, arsenous acid is used as a refining agent. The arsenous acid is an environment-affecting substance whose inverse effects to the environment are concerned not only in manufacturing processes but through the lifecycle of the product.

Accordingly, the inventors of the present invention heated and melted a glass material of the composition disclosed in the example of Patent Reference 2 without adding the arsenous acid, and found that only a glass can be obtained which hardly releases bubbles, that is, has a poor defoaming ability, and hence has many remaining bubbles. Specifically, after a molten glass was casted in a block shape and was sliced into a plate shape and the surface thereof was polished, it was recognized that a large number of pockmark-like dents (hereinafter referred to as open bubbles) formed by bubbles being cut in the glass is exposed on the polished surface.

For the purposes of housing or decoration of an electronic device as described above, a glass in which open bubbles exist cannot be used due to the demand for improving appearance quality, and thus causes a problem of largely reducing the production yield. There is also a concern that the open bubbles become an origin of crack and decrease the strength.

Further, the housing of an electronic device may be shaped and used not only in a flat plate shape but also in a concave or convex shape. Thus, a glass which is easily press-formed is demanded. Moreover, for the purpose of confirming that it has strength of a certain degree or more in quality management, a compressive stress value of the chemical strengthened glass is measured. However, when the glass has a dark color such as gray, if it is measured with an existing surface stress meter, there is a problem that the measurement light is absorbed by the glass and the measurement of compressive stress value cannot be performed. Accordingly, it is demanded that even such a glass having a gray-based color tone has transparency of a certain amount or more of light having a wavelength out of the visible range.

It is an object of the present invention to provide a glass for chemical strengthening having a gray-based color tone and excelling in characteristics preferred for the purposes of housing or decoration of an electronic device, that is, bubble quality, strength, and light transmission characteristics.

The present invention provides a glass for chemical strengthening (which may hereinafter be referred to as a first glass for chemical strengthening of the present invention) containing, in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (where R represents Mg, Ca, Sr, Ba, or Zn), 0.01% to 0.2% of Co₃O₄, 0.05% to 1% of NiO, and 0.005% to 3% of Fe₂O₃.

Further, the present invention provides a glass for chemical strengthening containing, in mole percentage based on following oxides, 55% to 80% of SiO₂, 3% to 16% of Al₂O₃, 0% to 12% of B₂O₃, 5% to 16% of Na₂O, 0% to 15% of K₂O, 0% to 15% of MgO, 0% to 3% of CaO, 0% to 18% of ΣRO (where R represents Mg, Ca, Sr, Ba, or Zn), 0.01% to 0.2% of Co₃O₄, 0.05% to 1% of NiO, and 0.005% to 3% of Fe₂O₃.

Further, the present invention provides a glass for chemical strengthening containing, in mole percentage based on following oxides, 55% to 80% of SiO₂, 0.25% to 5% of Al₂O₃, 0% to 12% of B₂O₃, 5% to 20% of Na₂O, 0% to 8% of K₂O, 0% to 15% of MgO, 5% to 15% of CaO, 5% to 25% of ΣRO (where R represents Mg, Ca, Sr, Ba, or Zn), 0.01% to 0.2% of Co₃O₄, 0.05% to 1% of NiO, and 0.005% to 3% of Fe₂O₃.

The present invention provides a glass for chemical strengthening (which may hereinafter be referred to as a second glass for chemical strengthening of the present invention) containing, in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃.

Further, the present invention provides the glass for chemical strengthening containing, in mole percentage based on following oxides, 55% to 80% of SiO₂, 3% to 16% of Al₂O₃, 0% to 12% of B₂O₃, 5% to 16% of Na₂O, 0% to 15% of K₂O, 0% to 15% of MgO, 0% to 3% of CaO, 0% to 18% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃.

Further, the present invention provides the glass for chemical strengthening containing, in mole percentage based on following oxides, 55% to 80% of SiO₂, 0.25% to 5% of Al₂O₃, 0% to 12% of B₂O₃, 5% to 20% of Na₂O, 0% to 8% of K₂O, 0% to 15% of MgO, 5% to 15% of CaO, 5% to 25% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃.

Further, the glass for chemical strengthening of the present invention is provided, containing 0.005% to 3% of a color correcting component having at least one metal oxide selected from the group consisting of oxides of Ti, Cu, Ce, Er, Nd, Mn, and Se.

Further, the glass for chemical strengthening is provided, containing 0.1% to 1% of TiO₂.

Further, the glass for chemical strengthening of the present invention is provided, containing 0.05% to 3% of CuO.
Further, the glass for chemical strengthening of the present invention is provided, containing 0.005% to 2% of a color correcting component having at least one metal oxide selected from the group consisting of oxides of Ce, Er, Nd, Mn, and Se.

Further, the glass for chemical strengthening of the present invention is provided, wherein a content ratio of Co₃O₄/Fe₂O₃ is 0.01 to 0.5.

Further, the glass for chemical strengthening of the present invention is provided, wherein a relative value of an absorption coefficient at a wavelength of 550 nm to an absorption coefficient at a wavelength of 600 nm, as calculated from a spectral transmittance curve of the glass, and a relative value of an absorption coefficient at a wavelength of 450 nm to an absorption coefficient at a wavelength of 600 nm, as calculated from a spectral transmittance curve of the glass are both in a range of 0.7 to 1.2. Further, the glass for chemical strengthening of the present invention is provided, wherein variation amounts ΔT (550/600) and ΔT (450/600) of relative values of absorption coefficients represented by following expressions (1) and (2) are 5% or less in absolute value.

ΔT(550/600)(%)=[{A(550/600)−B(550/600)}/A(550/600)]×100 (1)

ΔT(450/600)(%)=[{A(450/600)−B(450/600)}/A(450/600)]×100 (2)

In the above expression (1), A(550/600) is a relative value of an absorption coefficient at a wavelength of 550 nm to an absorption coefficient at a wavelength of 600 nm, as calculated from a spectral transmittance curve of the glass after irradiation with light of a 400 W high-pressure mercury lamp for 100 hours, and B(550/600) is a relative value of an absorption coefficient at a wavelength of 550 nm to an absorption coefficient at a wavelength of 600 nm, as calculated from a spectral transmittance curve of the glass before the light irradiation. In the above expression (2), A(450/600) is a relative value of an absorption coefficient at a wavelength of 450 nm to an absorption coefficient at a wavelength of 600 nm, as calculated from a spectral transmittance curve of the glass after irradiation with light of a 400 W high-pressure mercury lamp for 100 hours, and B(450/600) is a relative value of an absorption coefficient at a wavelength of 450 nm to an absorption coefficient at a wavelength of 600 nm, as calculated from a spectral transmittance curve of the glass before the light irradiation.
Further, the glass for chemical strengthening of the present invention is provided, wherein an absolute value of a difference Δa* between chromaticity a* of reflected light by a D65 light source and chromaticity a* of reflected light by an F2 light source in an L*a*b* color system, which difference is expressed by following expression (I), and an absolute value of a difference Δb* between chromaticity b* of reflected light by the D65 light source and chromaticity b* of reflected light by the F2 light source in the L*a*b* color system, which difference is expressed by following expression (II), are both 2 or less.

Δa*=a* value (D65 light source)−a* value (F2 light source) (I)

Δb*=b* value (D65 light source)−b* value (F2 light source) (II)

Further, the present invention provides a chemical strengthened glass obtained by chemical strengthening the above-described glass for chemical strengthening of the present invention, wherein a depth of a surface compressive stress layer formed in a surface of the chemical strengthened glass by the chemical strengthening is 5 μm or more, and a surface compressive stress of the surface compressive stress layer is 300 MPa or more.

Further, the present invention provides the chemical strengthened glass of the present invention, wherein an absolute value of a difference Δa* between chromaticity a* of reflected light by a D65 light source and chromaticity a* of reflected light by an F2 light source in an L*a*b* color system, which difference is expressed by following expression (I), and an absolute value of a difference Δb* between chromaticity b* of reflected light by the D65 light source and chromaticity b* of reflected light by the F2 light source in the L*a*b* color system, which difference is expressed by following expression (II), are both 2 or less.

Δa*=a* value (D65 light source)−a* value (F2 light source) (I)

Δb*=b* value (D65 light source)−b*value (F2 light source) (II)

Further, the present invention provides a manufacturing method of a glass for chemical strengthening, the method including blending plural kinds of chemical compound materials to make a glass material, heating and melting the glass material, and thereafter defoaming and cooling the glass material, to thereby manufacture a glass for chemical strengthening containing, in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (where R represents Mg, Ca, Sr, Ba, or Zn), 0.01% to 0.2% of Co₃O₄, 0.05% to 1% of NiO, and 0.005% to 3% of Fe₂O₃.

Further, the present invention provides the manufacturing method of a glass for chemical strengthening, the method including blending plural kinds of chemical compound materials to make a glass material, heating and melting the glass material, and thereafter defoaming and cooling the glass material, to thereby manufacture a glass for chemical strengthening containing, in mole percentage based on following oxides, 55% to 80% of SiO₂, 3% to 16% of Al₂O₃, 0% to 12% of B₂O₃, 5% to 16% of Na₂O, 0% to 15% of K₂O, 0% to 15% of MgO, 0% to 3% of CaO, 0% to 18% of ΣRO (where R represents Mg, Ca, Sr, Ba, or Zn), 0.01% to 0.2% of Co₃O₄, 0.05% to 1% of NiO, and 0.005% to 3% of Fe₂O₃.

Further, the present invention provides the manufacturing method of a glass for chemical strengthening, the method including blending plural kinds of chemical compound materials to make a glass material, heating and melting the glass material, and thereafter defoaming and cooling the glass material, to thereby manufacture a glass for chemical strengthening containing, in mole percentage based on following oxides, 55% to 80% of SiO₂, 0.25% to 5% of Al₂O₃, 0% to 12% of B₂O₃, 5% to 20% of Na₂O, 0% to 8% of K₂O, 0% to 15% of MgO, 5% to 15% of CaO, 5% to 25% of ΣRO (where R represents Mg, Ca, Sr, Ba, or Zn), 0.01% to 0.2% of Co₃O₄, 0.05% to 1% of NiO, and 0.005% to 3% of Fe₂O₃.

Further, the present invention provides a manufacturing method of a glass for chemical strengthening, the method including blending plural kinds of chemical compound materials to make a glass material, heating and melting the glass material, and thereafter defoaming and cooling the glass material, to thereby manufacture a glass for chemical strengthening containing, in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃.

Further, the present invention provides the manufacturing method of a glass for chemical strengthening, the method including blending plural kinds of chemical compound materials to make a glass material, heating and melting the glass material, and thereafter defoaming and cooling the glass material, to thereby manufacture a glass for chemical strengthening containing, in mole percentage based on following oxides, 55% to 80% of SiO₂, 3% to 16% of Al₂O₃, 0% to 12% of B₂O₃, 5% to 16% of Na₂O, 0% to 15% of K₂O, 0% to 15% of MgO, 0% to 3% of CaO, 0% to 18% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃.

Further, the present invention provides the manufacturing method of a glass for chemical strengthening, the method including blending plural kinds of chemical compound materials to make a glass material, heating and melting the glass material, and thereafter defoaming and cooling the glass material, to thereby manufacture a glass for chemical strengthening containing, in mole percentage based on following oxides, 55% to 80% of SiO₂, 0.25% to 5% of Al₂O₃, 0% to 12% of B₂O₃, 5% to 20% of Na₂O, 0% to 8% of K₂O, 0% to 15% of MgO, 5% to 15% of CaO, 5% to 25% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃.

According to the present invention, a glass having excellent bubble quality and having a gray-based color tone can be obtained stably while lowering its environmental load. Further, a glass for chemical strengthening preferred for refining with sulfate can be obtained. The glass of the present invention is also able to be chemically strengthened, and can be used preferably for purposes that require a small thickness and high strength, for example, decorative purposes. Further, in the glass for chemical strengthening of the present invention, breakage due to a crack does not easily occur, and hence a glass having high strength can be made. The glass of the present invention also excels in press formability, and can be processed in a desired shape required for housing purposes or the like at low cost.

### DETAILED DESCRIPTION

Hereinafter, preferred embodiments of a glass for chemical strengthening of the present invention will be described. Note that the present invention is not limited to the following embodiments.

A first glass for chemical strengthening of the present invention contains, in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (where R represents Mg, Ca, Sr, Ba, or Zn), 0.01% to 0.2% of Co₃O₄, 0.05% to 1% of NiO, and 0.005% to 3% of Fe₂O₃.

Note that ΣRO represents the total amount of all the RO components, that is, “MgO+CaO+SrO+BaO+ZnO”.

Note that in this description, the contents of coloring component and color correcting component indicate a converted content given that each component existing in the glass exists as the represented oxide.

For example, “containing 0.005% to 3% of Fe₂O₃” means an Fe content given that Fe existing in the glass exists entirely in the form of Fe₂O₃, that is, the Fe₂O₃-converted content of Fe is 0.005% to 3%.

The first glass for chemical strengthening of the present invention allows to obtain a gray-based colored glass by containing the above respective predetermined amounts of Co₃O₄, NiO, Fe₂O₃ as coloring components.

Further, a second glass for chemical strengthening of the present invention contains, in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃.

Note that ΣRO represents the total amount of all the RO components, that is, “MgO+CaO+SrO+BaO+ZnO”.

The second glass for chemical strengthening of the present invention allows to obtain a gray-based colored glass lighter in color than the first glass for chemical strengthening by containing the above respective predetermined amounts of Co₃O₄, NiO, Fe₂O₃ as coloring components.

For example, a glass for housing purposes may be shaped and used not only in a flat plate shape but also in a concave or convex shape. In this case, a glass formed in a flat plate shape, a block shape, or the like is reheated and press-formed in a molten state, or a molten glass is poured into a press mold and press formed, to be formed in a desired shape.

When the glass is press-formed, it is preferred that the formation temperature of the glass be low during press formation. Generally, when the formation temperature of the glass during press formation is high, a superalloy or ceramics must be used for the mold, but they are poor in workability and also expensive, and hence are not preferable. When the formation temperature of the glass during press formation is high, the progress of degradation of the mold is also accelerated because the mold is used under high temperature. Further, since the glass is made into a soften state at high temperature, a large amount of energy is needed.

The first glass for chemical strengthening of the present invention contains, in mole percentage based on oxides, 0.01% to 0.2% of Co₃O₄, 0.05% to 1% of NiO, and 0.005% to 3% of Fe₂O₃ in the glass, and this allows to lower Tg (glass transition point), which is an indicator of the formation temperature of the glass during press formation. Thus, a glass excellent in press formability can be made, which is suitable for press forming into an appropriate shape such as a concave or convex shape.

Further, the second glass for chemical strengthening of the present invention contains, in mole percentage based on oxides, 0.0005% or more and less than 0.01% of Co₃O₄, 0.01% to 1% of NiO, and 0.005% to 3% of Fe₂O₃ in the glass, and this allows to lower Tg (glass transition point), which is an indicator of the formation temperature of the glass during press formation. Thus, a glass excellent in press formability can be made, which is suitable for press forming into an appropriate shape such as a concave or convex shape.

To increase the absorption coefficient at wavelengths of 380 nm to 780 nm, it is preferred to make the absorption coefficients for light at these wavelengths be averagely high by combining and blending plural coloring components.

By containing 0.01% to 0.2% of Co₃O₄, 0.05% to 1% of NiO, and 0.005% to 3% of Fe₂O₃ as coloring components, the first glass for chemical strengthening of the present invention can be made as a glass which has a desired light blocking effect, sufficiently absorbs light in the visible range of wavelengths from 380 nm to 780 nm, and meanwhile averagely absorbs light in the visible range. That is, when it is attempted to obtain a glass exhibiting a gray color tone, depending on the type and blending amount of coloring components, a gray exhibiting brown or blue color may be generated due to the existence of a wavelength range with a low absorption characteristic in the visible range of wavelengths from 380 nm to 780 nm. In this respect, having the above-described coloring components allows to represent a good gray color tone, which is not brownish gray or bluish gray.

Further, by containing 0.0005% or more and less than 0.01% of Co₃O₄, 0.01% to 1% of NiO, and 0.005% to 3% of Fe₂O₃ as coloring components, the second glass for chemical strengthening of the present invention can be made as a glass which has a desired light blocking effect, sufficiently absorbs light in the visible range of wavelengths from 380 nm to 780 nm, and meanwhile averagely absorbs light in the visible range. That is, when it is attempted to obtain a glass exhibiting a gray color tone, depending on the type and blending amount of coloring components, a gray exhibiting brown or blue color may be generated due to the existence of a wavelength range with a low absorption characteristic in the visible range of wavelengths from 380 nm to 780 nm. In this respect, having the above-described coloring components allows to represent a good gray color tone, which is not brownish gray or bluish gray.

Further, by combining coloring components in the glass, a glass can be made that has transparency of certain wavelengths of ultraviolet light, infrared light, or the like while sufficiently absorbing light in the visible range of wavelengths from 380 nm to 780 nm. By containing Co₃O₄, NiO, Fe₂O₃ as coloring components, the first glass for chemical strengthening and the second glass for chemical strengthening of the present invention can be made as a glass which can have transparency of ultraviolet light at wavelengths of 300 nm to 380 nm as well as infrared light at wavelengths of 800 nm to 950 nm. For example, the infrared light at wavelengths of 800 nm to 950 nm is utilized in an infrared communication device used in data communication of a portable phone or a portable game device. Accordingly, giving an infrared light transmitting characteristic to a glass by blending the above-described coloring components (Co₃O₄, NiO, and Fe₂O₃) enables that, when the glass is applied to housing purposes for example, it can be applied without providing an opening for the infrared light communication device in the housing.

It is preferred that the first glass for chemical strengthening and the second glass for chemical strengthening of the present invention contain, as a color correcting component, 0.005% to 3%, more preferably 0.01% to 2.5% in total of at least one metal oxide selected from the group consisting of oxides of Ti, Cu, Ce, Er, Nd, Mn, and Se. By containing 0.005% or more in total of the above-described color correcting components, a difference in absorption characteristic of light within the wavelength range of a visible range can be reduced, thereby allowing to represent a good gray color tone, which is not brownish color tone or bluish color tone in a glass of a gray color tone. On the other hand, when the content of the above-described color correcting components is more than 3% in total, it is possible that the glass becomes unstable and devitrification occurs.

In view of obtaining a good gray color tone which does not exhibit brownish or bluish color, it is preferred to contain, as the color correcting component, 0.005% to 2%, more preferably 0.01% to 1.5% in total of at least one metal oxide selected from the group consisting of oxides of Ce, Er, Nd, Mn, and Se.

As the color correcting component, specifically, for example, TiO₂, CuO, Cu₂O, Ce₂O₂, Er₂O₃, Nd₂O₃, MnO₂, SeO₂ are used preferably.

As the first glass for chemical strengthening and the second glass for chemical strengthening of the present invention, one can be exemplified which contains, together with the above-described coloring components, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, and 0% to 25% of ΣRO (where R represents Mg, Ca, Sr, Ba, or Zn).

Hereinafter, compositions of glasses other than coloring components (Co₃O₄, NiO, Fe₂O₃) of the first glass for chemical strengthening and the second glass for chemical strengthening of the present invention will be described using a content expressed in mole percentage unless otherwise stated.

SiO₂ is a component that forms a skeletal structure of the glass and hence is essential. When its content is less than 55%, stability as a glass decreases, or weather resistance decreases. Preferably, its content is 61% or more. More preferably, its content is 65% or more. When the content of SiO₂ is more than 80%, viscosity of the glass increases, and meltability decreases significantly. Preferably, its content is 75% or less, typically 70% or less.

Al₂O₃ is a component that improves weather resistance and chemical strengthening characteristic of the glass and is essential. When its content is less than 0.25%, the weather resistance decreases. Preferably, its content is 0.3% or more, typically 0.5% or more. When the content of Al₂O₃ is more than 16%, viscosity of the glass becomes high and uniform melting becomes difficult. Preferably, its content is 14% or less, typically 12% or less.

B₂O₃ is a component that improves weather resistance, and is not essential but preferred to be contained. When B₂O₃ is contained, if its content is less than 0.01%, it is possible that a significant effect cannot be obtained regarding improvement of the weather resistance. Preferably, its content is 4% or more, typically 5% or more. When the content of B₂O₃ is more than 12%, it is possible that striae due to volatilization occur and the yield decreases. Preferably, its content is 11% or less, typically 10% or less.

Na₂O is a component that improves meltability of the glass, and is essential because it causes a surface compressive stress layer to be formed by ion exchange. When its content is less than 5%, the meltability is poor and it is also difficult to form a desired surface compressive stress layer by ion exchange. Preferably, its content is 7% or more, typically 8% or more. The weather resistance decreases when the content of Na₂O is more than 20%. Preferably, its content is 18% or less, typically 16% or less.

K₂O is a component that improves meltability, and has an operation to increase ion exchange speed in chemical strengthening. Thus, this component is not essential but is preferred to be contained. When K₂O is contained, if its content is less than 0.01%, it is possible that a significant effect cannot be obtained regarding improvement of meltability, or that a significant effect cannot be obtained regarding ion exchange speed improvement. Typically, its content is 0.3% or more. When the content of K₂O is more than 15%, weather resistance decreases. Preferably, its content is 12% or less, typically 10% or less.

MgO is a component that improves meltability, and is not essential but can be contained as necessary. When MgO is contained, if its content is less than 3%, it is possible that a significant effect cannot be obtained regarding improvement of meltability. Typically, its content is 4% or more. When the content of MgO is more than 15%, weather resistance decreases. Preferably, its content is 13% or less, typically 12% or less.

CaO is a component that improves meltability and can be contained as necessary. When CaO is contained, if its content is less than 0.01%, a significant effect cannot be obtained regarding improvement of meltability. Typically, its content is 0.1% or more. When the content of CaO is more than 15%, the chemical strengthening characteristic decreases. Preferably, its content is 12% or less, typically 10% or less. Practically, it is preferred not to be contained.

RO (where R represents Mg, Ca, Sr, Ba, or Zn) is a component that improves meltability and is not essential, but any one or more of them can be contained as necessary. In this case, it is possible that the meltability decreases when the total content of RO i.e. ΣRO (where R represents Mg, Ca, Sr, Ba, or Zn) is less than 1%. Preferably, its content is 3% or more, typically 5% or more. When the content of ΣRO (where R represents Mg, Ca, Sr, Ba, or Zn) is more than 25%, weather resistance decreases. Preferably, its content is 20% or less, more preferably 18% or less, typically 16% or less.

ZrO₂ is a component that increases ion exchange speed and is not essential, but may be contained as necessary. When ZrO₂ is contained, its content is preferably in the range of 5% or less, more preferably in the range of 4% or less, furthermore preferably in the range of 3% or less. When the content of ZrO₂ is more than 5%, meltability worsens and there may be cases where it remains as a non-melted matter in the glass. Typically, it is not contained.

There are two embodiments (a first embodiment and a second embodiment) which will be described below as preferred embodiments for the first glass for chemical strengthening and the second glass for chemical strengthening of the present invention respectively.

First embodiments of the first glass for chemical strengthening and the second glass for chemical strengthening will be described.

Regarding the first embodiments of the first glass for chemical strengthening and the second glass for chemical strengthening of the present invention below, the composition will be described using a content expressed in mole percentage unless otherwise stated.

The first embodiment of the first glass for chemical strengthening of the present invention contains, in mole percentage based on following oxides, 55% to 80% of SiO₂, 3% to 16% of Al₂O₃, 0% to 12% of B₂O₃, 5% to 16% of Na₂O, 0% to 15% of K₂O, 0% to 15% of MgO, 0% to 3% of CaO, 0% to 18% of ΣRO (where R represents Mg, Ca, Sr, Ba, or Zn), 0.01% to 0.2% of Co₃O₄, 0.05% to 1% of NiO, and 0.005% to 3% of Fe₂O₃.

Further, the first embodiment of the second glass for chemical strengthening of the present invention contains, in mole percentage based on following oxides, 55% to 80% of SiO₂, 3% to 16% of Al₂O₃, 0% to 12% of B₂O₃, 5% to 16% of Na₂O, 0% to 15% of K₂O, 0% to 15% of MgO, 0% to 3% of CaO, 0% to 18% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃.

Note that the first embodiment of the first glass for chemical strengthening and the first embodiment of the second glass for chemical strengthening have the same components and the same composition ranges regarding the components other than Co₃O₄ and NiO. Thus, explanations of the first embodiment of the first glass for chemical strengthening and the first embodiment of the second glass for chemical strengthening are in common regarding the composition ranges of the components other than Co₃O₄ and NiO.

SiO₂ is a component that forms a skeletal structure of the glass and hence is essential. When its content is less than 55%, stability as a glass decreases, or weather resistance decreases. Preferably, its content is 61% or more. More preferably, its content is 65% or more. When the content of SiO₂ is more than 80%, viscosity of the glass increases, and meltability decreases significantly. Preferably, its content is 75% or less, typically 70% or less.

Al₂O₃ is a component that improves weather resistance and chemical strengthening characteristic of the glass and is essential. When its content is less than 3%, the weather resistance decreases. Preferably, its content is 4% or more, typically 5% or more. When the content of Al₂O₃ is more than 16%, viscosity of the glass becomes high and uniform melting becomes difficult. Preferably, its content is 14% or less, typically 12% or less.

B₂O₃ is a component that improves weather resistance, and is not essential but preferred to be contained. When B₂O₃ is contained, if its content is less than 0.01%, it is possible that a significant effect cannot be obtained regarding improvement of the weather resistance. Preferably, its content is 4% or more, typically 5% or more. When the content of B₂O₃ is more than 12%, it is possible that striae due to volatilization occur and the yield decreases. Preferably, its content is 11% or less, typically 10% or less.

Na₂O is a component that improves meltability of the glass, and is essential because it causes a surface compressive stress layer to be formed by ion exchange. When its content is less than 5%, the meltability is poor and it is also difficult to form a desired surface compressive stress layer by ion exchange. Preferably, its content is 7% or more, typically 8% or more. The weather resistance decreases when the content of Na₂O is more than 16%. Preferably, its content is 15% or less, typically 14% or less.

K₂O is a component that improves meltability, and has an operation to increase ion exchange speed in chemical strengthening. Thus, this component is not essential but is preferred to be contained. When K₂O is contained, if its content is less than 0.01%, it is possible that a significant effect cannot be obtained regarding improvement of meltability, or that a significant effect cannot be obtained regarding ion exchange speed improvement. Typically, its content is 0.3% or more. When the content of K₂O is more than 15%, weather resistance decreases. Preferably, its content is 10% or less, typically 8% or less.

MgO is a component that improves meltability, and is not essential but can be contained as necessary. When MgO is contained, if its content is less than 3%, it is possible that a significant effect cannot be obtained regarding improvement of meltability. Typically, its content is 4% or more. When the content of MgO is more than 15%, weather resistance decreases. Preferably, its content is 13% or less, typically 12% or less.

CaO is a component that improves meltability and can be contained as necessary. When CaO is contained, if its content is less than 0.01%, a significant effect cannot be obtained regarding improvement of meltability. Typically, its content is 0.1% or more. When the content of CaO is more than 3%, the chemical strengthening characteristic decreases. Preferably, its content is 1% or less, typically 0.5% or less. Practically, it is preferred not to be contained.

RO (where R represents Mg, Ca, Sr, Ba, or Zn) is a component that improves meltability and is not essential, but any one or more of them can be contained as necessary. In this case, it is possible that the meltability decreases when the total content of RO i.e. ΣRO (where R represents Mg, Ca, Sr, Ba, or Zn) is less than 1%. Preferably, its content is 3% or more, typically 5% or more. When the content of ΣRO (where R represents Mg, Ca, Sr, Ba, or Zn) is more than 18%, weather resistance decreases. Preferably, its content is 15% or less, more preferably 13% or less, typically 11% or less.

ZrO₂ is a component that increases ion exchange speed and is not essential, but may be contained as necessary. When ZrO₂ is contained, its content is preferably in the range of 5% or less, more preferably in the range of 4% or less, furthermore preferably in the range of 3% or less. When the content of ZrO₂ is more than 5%, meltability worsens and there may be cases where it remains as a non-melted matter in the glass. Typically, it is not contained.

Fe₂O₃ is an essential component for coloring a glass with a deep color. When the total iron content represented by Fe₂O₃ is less than 0.005%, a desired gray glass cannot be obtained. Preferably, its content is 0.01% or more, more preferably 0.015% or more. When the content of Fe₂O₃ is more than 3%, the color tone of the glass becomes excessively dark, and a desired gray color tone cannot be obtained. Further, the glass becomes unstable and devitrification occurs. Preferably, its content is 2.5% or less, more preferably 2.2% or less.

It is preferred that, among the total iron, the ratio of divalent iron content (iron redox) converted by Fe₂O₃ be 10% to 50%, particularly 15% to 40%. Most preferably, the iron redox is 20% to 30%. When the iron redox is less than 10%, decomposition of SO₃ does not proceed when it is contained, and it is possible that an expected refining effect cannot be obtained. When the iron redox is more than 50%, decomposition of SO₃ proceeds too much before refining, and it is possible that the expected refining effect cannot be obtained, or that it becomes a source of bubbles and increases the number of bubbles.

In this description, the content of the total iron converted into Fe₂O₃ represents the content of Fe₂O₃. Regarding the iron redox, the ratio of bivalent iron converted into Fe₂O₃ among the total iron converted into Fe₂O₃ by a Mossbauer spectroscopy can be represented by percent. Specifically, evaluation is performed with a transmission optical system in which a radiation source (⁵⁷Co), a glass sample (a glass flat plate having a thickness of 3 mm to 7 mm which is cut from the above-described glass block, grinded, and mirror polished), and a detector (45431 made by LND, Inc.) are disposed on a straight line. The radiation source is moved with respect to an axial direction of the optical system, so as to cause an energy change of γ ray by a Doppler effect.

Then, a Mossbauer absorption spectrum obtained at room temperature is used to calculate the ratio of bivalent iron to the total iron and the ratio of trivalent iron to the total iron, and the ratio of bivalent Fe to the total iron is taken as the iron redox.

Co₃O₄ is a coloring component for coloring a glass with a deep color, and in the first glass for chemical strengthening, when the content of Co₃O₄ is less than 0.01%, a desired gray color tone in a glass cannot be obtained. Preferably, its content is 0.02% or more, more preferably 0.03% or more. When the content of Co₃O₄ is more than 0.2%, the color tone of the glass becomes excessively dark, and a desired gray color tone cannot be obtained. Preferably, its content is 0.15% or less, more preferably 0.12% or less.

Further, in the second glass for chemical strengthening, when the content of Co₃O₄ is less than 0.0005%, a desired gray color tone in a glass cannot be obtained. Preferably, its content is 0.00075% or more, more preferably 0.001% or more. When the content of Co₃O₄ is 0.01% or more, the color tone of the glass becomes excessively dark, and a desired thin gray color tone cannot be obtained. Preferably, its content is 0.009% or less, more preferably 0.008% or less.

Co₃O₄ is a coloring component for coloring a glass with a deep color, and is a component which exhibits a defoaming effect while coexisting with iron and is essential. Specifically, O₂ bubbles discharged when trivalent iron becomes bivalent iron in a high-temperature state are absorbed when cobalt is oxidized. Consequently the O₂ bubbles are reduced, and thus the defoaming effect is obtained.

Moreover, Co₃O₄ is a component that further increases the refining operation when being allowed to coexist with SO₃. Specifically, for example, when a sodium sulfate (Na₂SO₄) is used as a refining agent, defoaming from the glass improves by allowing the reaction SO₃→SO₂+½O₂ to proceed, and thus the oxygen partial pressure in the glass is preferred to be low. By co-adding cobalt to a glass containing iron, release of oxygen occurring due to reduction of iron can be suppressed by oxidation of cobalt, and thus decomposition of SO₃ is accelerated. Thus, it is possible to produce a glass with a small bubble defect.

Further, in a glass containing a relatively large amount of alkali metal for chemical strengthening, basicity of the glass increases, SO₃ does not decompose easily, and the refining effect decreases. In this manner, in one containing iron in the glass for chemical strengthening in which SO₃ does not decompose easily, cobalt accelerates decomposition of SO₃, and hence is effective in particular for acceleration of the defoaming effect.

In the first glass for chemical strengthening, in order for such a refining operation to occur, Co₃O₄ is 0.01% or more, preferably 0.02% or more, typically 0.03% or more.

When its content is more than 0.2%, the glass becomes unstable and devitrification occurs. Preferably, its content is 0.18% or less, more preferably 0.15% or less.

Further, in the second glass for chemical strengthening, in order for such a refining operation to occur, Co₃O₄ is 0.0005% or more, preferably 0.00075% or more, typically 0.001% or more.

When the mole ratio of the content of Co₃O₄ and the content of Fe₂O₃, that is, the content ratio of Co₃O₄/Fe₂O₃ is less than 0.01, it is possible that the above-described defoaming effect cannot be obtained. Preferably, the content ratio is 0.05 or more, typically 0.1 or more. When the content ratio of Co₃O₄/Fe₂O₃ is more than 0.5, it inversely becomes a source of bubbles, and it is possible that melting down of the glass becomes slow or the number of bubbles increases. Thus, a countermeasure such as using a separate refining agent, or the like needs to be taken. Preferably, the content ratio is 0.3 or less, more preferably 0.2 or less.

NiO is a coloring component for coloring a glass with a desired gray color tone, and is an essential component in the first glass for chemical strengthening. In the first glass for chemical strengthening, when the content of NiO is less than 0.05%, a desired gray color tone in a glass cannot be obtained. Preferably, its content is 0.1% or more, more preferably 0.2% or more. In the first glass for chemical strengthening, when the content of NiO is more than 1%, brightness of the glass becomes excessively high, and a desired gray color tone cannot be obtained. Further, the glass becomes unstable and devitrification occurs. Preferably, its content is 0.9% or less, more preferably 0.8% or less.

Further, in the second glass for chemical strengthening, NiO is an essential component.

In the second glass for chemical strengthening, when the content of NiO is less than 0.01%, a desired gray color tone in a glass cannot be obtained. Preferably, its content is 0.03% or more, more preferably 0.07% or more. In the second glass for chemical strengthening, when the content of NiO is more than 1%, brightness of the glass becomes excessively high, and a desired gray color tone cannot be obtained. Further, the glass becomes unstable and devitrification occurs. Preferably, its content is 0.9% or less, more preferably 0.8% or less.

(SiO₂+Al₂O₃+B₂O₃)/(ΣR′₂O+CaO+SrO+BaO+Fe₂O₃+CO₃O₄) represents the ratio of the total content of reticulate oxides forming the network of the glass and the total content of a main modified oxide. Note that ΣR′₂O represents the total amount of all R′₂O components, that is, “Na₂O+K₂O+Li₂O”. When this ratio is less than 3, it is possible that the probability of breakage when an indentation is made after the chemical strengthening becomes large. Preferably, the ratio is 3.6 or more, typically 4 or more. When this ratio is more than 6, viscosity of the glass increases, and meltability of the glass decreases. Preferably, the ratio is 5.5 or less, more preferably 5 or less.

SO₃ is a component that operates as a refining agent, and is not essential but can be contained as necessary. When SO₃ is contained, an expected refining operation cannot be obtained if its content is less than 0.005%. Preferably, its content is 0.01% or more, more preferably 0.02% or more. Most preferably, its content is 0.03% or more. Further, when its content is more than 0.5%, it inversely becomes a source of bubbles, and it is possible that melting down of the glass becomes slow or the number of bubbles increases. Preferably, its content is 0.3% or less, more preferably 0.2% or less. Most preferably, its content is 0.1% or less.

SnO₂ is a component that operates as a refining agent, and is not essential but can be contained as necessary. When SnO₂ is contained, an expected refining operation cannot be obtained if its content is less than 0.005%. Preferably, its content is 0.01% or more, more preferably 0.05% or more. Further, when its content is more than 1%, it inversely becomes a source of bubbles, and it is possible that melting down of the glass becomes slow or the number of bubbles increases. Preferably, its content is 0.8% or less, more preferably 0.5% or less. Most preferably, its content is 0.3% or less.

TiO₂ is a component that improves weather resistance and adjusts the color tone of the glass to correct the color, and is not essential but can be contained as necessary. When TiO₂ is contained, a sufficient color correcting effect cannot be obtained if its content is less than 0.1%, and it is possible that a gay-based glass cannot be prevented sufficiently from exhibiting a bluish gray or brownish gray color. It is also possible that a significant effect cannot be obtained regarding improvement of weather resistance. Preferably, its content is 0.15% or more, typically 0.2% or more. When the content of TiO₂ is more than 1%, it is possible that the glass becomes unstable and devitrification occurs. Preferably, its content is 0.8% or less, typically 0.6% or less.

CuO is a component that adjusts the color tone of a glass to correct the color, and is not essential but can be contained as necessary. Further, CuO has an effect to lower metamerism when it is contained in a glass.

The metamerism is an index indicating the degree of a color change of a color tone or an outer color due to color of outside light and can be defined by using the L*a*b* color system standardized by CIE (International Commission Illumination). The lower the metamerism, the smaller the degree of the color change of the color tone or the outer color due to the color of the outside light. For example, when the metamerism of the glass is high, the color tone becomes greatly different due to an external light source, and the color tone of the glass indoors and the color tone of the glass outdoors differ greatly.

By containing CuO, the glass for chemical strengthening of the present invention can easily make an absolute value of Δa* defined by the following expression (I) and an absolute value of Δb* defined by the following expression (II) both be 2 or less. This can reduce the difference between a reflected color tone of the glass indoors and a reflected color tone of the glass outdoors.

(i) a difference Δa* between chromaticity a* of reflected light by a D65 light source and chromaticity a* of reflected light by an F2 light source in an L*a*b* color system

Δa*=a* value (D65 light source)−a* value (F2 light source) (I)

(ii) a difference Δb* between chromaticity b* of reflected light by a D65 light source and chromaticity b* of reflected light by an F2 light source in an L*a*b* color system

Δb*=b* value (D65 light source)−b* value (F2 light source) (II)

When CuO is contained, if its content is less than 0.05%, it is possible that a significant effect cannot be obtained regarding adjustment of color tone or suppression of metamerism. Preferably, its content is 0.2% or more, typically, 0.5% or more. When the content of CuO is more than 3%, it is possible that the glass becomes unstable and devitrification occurs. Preferably, its content is 2.5% or less, typically 2% or less.

Note that regarding Fe₂O₃, when it is contained in the glass, there is an effect to reduce the metamerism similarly to CuO. The content of Fe₂O₃ by which the significant effect regarding the metamerism can be obtained is preferably 0.05% to 2%, typically 0.3% to 1.5%.

Li₂O is a component for improving meltability, and is not essential but can be contained as necessary. When Li₂O is contained, it is possible that a significant effect cannot be obtained regarding improvement of meltability if its content is less than 1%. Preferably, its content is 3% or more, typically 6% or more. When the content of Li₂O is more than 15%, it is possible that weather resistance decreases. Preferably, its content is 10% or less, typically 5% or less.

SrO is a component for improving meltability, and is not essential but can be contained as necessary. When SrO is contained, it is possible that a significant effect cannot be obtained regarding improvement of meltability if its content is less than 1%. Preferably, its content is 3% or more, typically 6% or more. When the content of SrO is more than 15%, it is possible that weather resistance and chemical strengthening characteristic decrease. Preferably, its content is 12% or less, typically 9% or less.

BaO is a component for improving meltability, and is not essential but can be contained as necessary. When BaO is contained, it is possible that a significant effect cannot be obtained regarding improvement of meltability if its content is less than 1%. Preferably, its content is 3% or more, typically 6% or more. When the content of BaO is more than 15%, it is possible that weather resistance and chemical strengthening characteristic decrease. Preferably, its content is 12% or less, typically 9% or less.

ZnO is a component for improving meltability, and is not essential but can be contained as necessary. When ZnO is contained, it is possible that a significant effect cannot be obtained regarding improvement of meltability if its content is less than 1%. Preferably, its content is 3% or more, typically 6% or more. When the content of ZnO is more than 15%, it is possible that weather resistance decreases. Preferably, its content is 12% or less, typically 9% or less.

CeO₂, Er₂O₃, Nd₂O₃, MnO₂ and SeO₂ are color correcting components for adjusting the color tone of the glass, and are not essential but can be contained as necessary.

When these color correcting components are contained, if each content of them is less than 0.005% the effect of adjustment of color tone, that is, color correction cannot be obtained sufficiently, and it is possible that exhibition of, for example, bluish gray or brownish gray color tone cannot be prevented sufficiently. Each content of these color correcting components is preferably 0.05% or more, typically 0.1% or more. When each content of the color correcting components is more than 2%, it is possible that the glass becomes unstable and devitrification occurs. Typically, its content is 1.5% or less.

Note that the type and amount of the above-described color correcting components can be appropriately selected and used depending on the component to be the parent component of each glass.

As the above-described color correcting components, it is preferred that the total content of TiO₂, CuO, Cu₂O, CeO₂, Er₂O₃, Nd₂O₃, MnO₂ and SeO₂ be 0.005% to 3%, and it is preferred that the total content of CeO₂, Er₂O₃, Nd₂O₃, MnO₂ and SeO₂ be 0.005% to 2%.

By having the content of the color correcting components in the above-described range, a sufficient color correcting effect can be obtained, and a stable glass can be obtained.

In the glass for chemical strengthening of the present invention, Co is a coloring component and is also a refining agent. As the refining agent of the glass, SO₃ or SnO₂ may be used as necessary, but Sb₂O₃, Cl, F, and another component may be contained within the range not impairing the object of the present invention. When such a component is contained, it is preferred that the total content of these components be 1% or less, typically 0.5% or less. Note that As₂O₃ is an environment-affecting substance with which inverse effects to the environment are concerned not only in manufacturing processes but through the lifecycle of the product, and hence is not contained.

Next, second embodiments of the first glass for chemical strengthening and the second glass for chemical strengthening will be described.

Regarding the second embodiments of the first glass for chemical strengthening and the second glass for chemical strengthening of the present invention below, the composition will be described using a content expressed in mole percentage unless otherwise stated.

The second embodiment of the first glass for chemical strengthening of the present invention contains, in mole percentage based on following oxides, 55% to 80% of SiO₂, 0.25% to 5% of Al₂O₃, 0% to 12% of B₂O₃, 5% to 20% of Na₂O, 0% to 8% of K₂O, 0% to 15% of MgO, 5% to 15% of CaO, 5% to 25% of ΣRO (where R represents Mg, Ca, Sr, Ba, or Zn), 0.01% to 0.2% of Co₃O₄, 0.05% to 1% of NiO, and 0.005% to 3% of Fe₂O₃.

The second embodiment of the second glass for chemical strengthening of the present invention contains, in mole percentage based on following oxides, 55% to 80% of SiO₂, 0.25% to 5% of Al₂O₃, 0% to 12% of B₂O₃, 5% to 20% of Na₂O, 0% to 8% of K₂O, 0% to 15% of MgO, 5% to 15% of CaO, 5% to 25% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃.

Note that the second embodiment of the first glass for chemical strengthening and the second embodiment of the second glass for chemical strengthening have the same components and the same composition ranges regarding the components other than Co₃O₄ and NiO. Thus, explanations of the second embodiment of the first glass for chemical strengthening and the second embodiment of the second glass for chemical strengthening are in common regarding the composition ranges of the components other than Co₃O₄ and NiO.

SiO₂ is a component that forms a skeletal structure of the glass and hence is essential. When its content is less than 55%, stability as a glass decreases, or weather resistance decreases. Preferably, its content is 61% or more. More preferably, its content is 65% or more. When the content of SiO₂ is more than 80%, viscosity of the glass increases, and meltability decreases significantly. Preferably, its content is 75% or less, typically 70% or less.

Al₂O₃is a component that improves weather resistance and chemical strengthening characteristic of the glass and is essential. When its content is less than 0.25%, the weather resistance decreases. Preferably, its content is 0.3% or more, typically 0.5% or more. When the content of Al₂O₃ is more than 5%, viscosity of the glass becomes high and uniform melting becomes difficult. Preferably, its content is 4% or less, typically 3% or less.

B₂O₃ is a component that improves weather resistance, and is not essential but preferred to be contained. When B₂O₃ is contained, if its content is less than 0.01%, it is possible that a significant effect cannot be obtained regarding improvement of the weather resistance. Preferably, its content is 4% or more, typically 5% or more. When the content of B₂O₃ is more than 12%, it is possible that striae due to volatilization occur and the yield decreases. Preferably, its content is 11% or less, typically 10% or less.

Na₂O is a component that improves meltability of the glass, and is essential because it causes a surface compressive stress layer to be formed by ion exchange. When its content is less than 5%, the meltability is poor and it is also difficult to form a desired surface compressive stress layer by ion exchange. Preferably, its content is 7% or more, typically 8% or more. The weather resistance decreases when the content of Na₂O is more than 20%. Preferably, its content is 18% or less, typically 16% or less.

K₂O is a component that improves meltability, and has an operation to increase ion exchange speed in chemical strengthening. Thus, this component is not essential but is preferred to be contained. When K₂O is contained, if its content is less than 0.01%, it is possible that a significant effect cannot be obtained regarding improvement of meltability, or that a significant effect cannot be obtained regarding ion exchange speed improvement. Typically, its content is 0.3% or more. When the content of K₂O is more than 8%, weather resistance decreases. Preferably, its content is 7% or less, typically 6% or less.

MgO is a component that improves meltability, and is not essential but can be contained as necessary. When MgO is contained, if its content is less than 3%, it is possible that a significant effect cannot be obtained regarding improvement of meltability. Typically, its content is 4% or more. When the content of MgO is more than 15%, weather resistance decreases. Preferably, its content is 13% or less, typically 12% or less.

CaO is a component that improves meltability and is essential. When its content is less than 5%, a significant effect cannot be obtained regarding improvement of meltability. Typically, its content is 6% or more. When the content of CaO is more than 15%, the chemical strengthening characteristic decreases. Preferably, its content is 14% or less, typically 13% or less.

RO (where R represents Mg, Ca, Sr, Ba, or Zn) is a component that improves meltability. Among them Ca is essential and other than Ca are not essential but any one or more of them can be contained as necessary. In this case, the meltability decreases when the total content of RO i.e. ΣRO (where R represents Mg, Ca, Sr, Ba, or Zn) is less than 5%. Typically, its content is 6% or more. When the content of ΣRO (where R represents Mg, Ca, Sr, Ba, or Zn) is more than 25%, weather resistance decreases. Preferably, its content is 20% or less, more preferably 18% or less, typically 16% or less.

ZrO₂ is a component that increases ion exchange speed and is not essential, but may be contained as necessary. When ZrO₂ is contained, its content is preferably in the range of 5% or less, more preferably in the range of 4% or less, furthermore preferably in the range of 3% or less. When the content of ZrO₂ is more than 5%, meltability worsens and there may be cases where it remains as a non-melted matter in the glass. Typically, it is not contained.

Fe₂O₃ is an essential component for coloring a glass with a deep color. When the total iron content represented by Fe₂O₃ is less than 0.005%, a desired gray glass cannot be obtained. Preferably, its content is 0.01% or more, more preferably 0.015% or more. When the content of Fe₂O₃ is more than 3%, the color tone of the glass becomes excessively dark, and a desired gray color tone cannot be obtained. Further, the glass becomes unstable and devitrification occurs. Preferably, its content is 2.5% or less, more preferably 2.2% or less.

It is preferred that, among the total iron, the ratio of divalent iron content (iron redox) converted by Fe₂O₃ be 10% to 50%, particularly 15% to 40%. Most preferably, the iron redox is 20% to 30%. When the iron redox is less than 10%, decomposition of SO₃ does not proceed when it is contained, and it is possible that an expected refining effect cannot be obtained. When the iron redox is more than 50%, decomposition of SO₃ proceeds too much before refining, and it is possible that the expected refining effect cannot be obtained, or that it becomes a source of bubbles and increases the number of bubbles.

In this description, the content of the total iron converted into Fe₂O₃ represents the content of Fe₂O₃. Regarding the iron redox, the ratio of bivalent iron converted into Fe₂O₃ among the total iron converted into Fe₂O₃ by a Mossbauer spectroscopy can be represented by percent. Specifically, evaluation is performed with a transmission optical system in which a radiation source (⁵⁷Co), a glass sample (a glass flat plate having a thickness of 3 mm to 7 mm which is cut from the above-described glass block, grinded, and mirror polished), and a detector (45431 made by LND, Inc.) are disposed on a straight line. The radiation source is moved with respect to an axial direction of the optical system, so as to cause an energy change of y ray by a Doppler effect.

Then, a Mossbauer absorption spectrum obtained at room temperature is used to calculate the ratio of bivalent iron to the total iron and the ratio of trivalent iron to the total iron, and the ratio of bivalent Fe to the total iron is taken as the iron redox.

Co₃O₄ is a coloring component for coloring a glass with a deep color, and in the first glass for chemical strengthening, when the content of Co₃O₄ is less than 0.01%, a desired gray color tone in a glass cannot be obtained. Preferably, its content is 0.02% or more, more preferably 0.03% or more. When the content of Co₃O₄ is more than 0.2%, the color tone of the glass becomes excessively dark, and a desired gray color tone cannot be obtained. Preferably, its content is 0.15% or less, more preferably 0.12% or less.

Further, in the second glass for chemical strengthening, when the content of Co₃O₄ is less than 0.0005%, a desired gray color tone in a glass cannot be obtained. Preferably, its content is 0.00075% or more, more preferably 0.001% or more. When the content of Co₃O₄ is 0.01% or more, the color tone of the glass becomes excessively dark, and a desired thin gray color tone cannot be obtained. Preferably, its content is 0.009% or less, more preferably 0.008% or less.

Co₃O₄ is a coloring component for coloring a glass with a deep color, and is a component which exhibits a defoaming effect while coexisting with iron and is essential. Specifically, O₂ bubbles discharged when trivalent iron becomes bivalent iron in a high-temperature state are absorbed when cobalt is oxidized. Consequently the O₂ bubbles are reduced, and thus the defoaming effect is obtained.

Moreover, Co₃O₄ is a component that further increases the refining operation when being allowed to coexist with SO₃. Specifically, for example, when a sodium sulfate (Na₂SO₄) is used as a refining agent, defoaming from the glass improves by allowing the reaction SO₃→SO₂+½O₂ to proceed, and thus the oxygen partial pressure in the glass is preferred to be low. By co-adding cobalt to a glass containing iron, release of oxygen occurring due to reduction of iron can be suppressed by oxidation of cobalt, and thus decomposition of SO₃ is accelerated. Thus, it is possible to produce a glass with a small bubble defect.

Further, in a glass containing a relatively large amount of alkali metal for chemical strengthening, basicity of the glass increases, SO₃ does not decompose easily, and the refining effect decreases. In this manner, in one containing iron in the glass for chemical strengthening in which SO₃ does not decompose easily, cobalt accelerates decomposition of SO₃, and hence is effective in particular for acceleration of the defoaming effect.

In the first glass for chemical strengthening, in order for such a refining operation to occur, Co₃O₄ is 0.01% or more, preferably 0.02% or more, typically 0.03% or more.

When its content is more than 0.2%, the glass becomes unstable and devitrification occurs. Preferably, its content is 0.18% or less, more preferably 0.15% or less.

Further, in the second glass for chemical strengthening, in order for such a refining operation to occur, Co₃O₄ is 0.0005% or more, preferably 0.00075% or more, typically 0.001% or more.

When the mole ratio of the content of Co₃O₄ and the content of Fe₂O₃, that is, the content ratio of Co₃O₄/Fe₂O₃ is less than 0.01, it is possible that the above-described defoaming effect cannot be obtained. Preferably, the content ratio is 0.05 or more, typically 0.1 or more. When the content ratio of Co₃O₄/Fe₂O₃ is more than 0.5, it inversely becomes a source of bubbles, and it is possible that melting down of the glass becomes slow or the number of bubbles increases. Thus, a countermeasure such as using a separate refining agent, or the like needs to be taken. Preferably, the content ratio is 0.3 or less, more preferably 0.2 or less.

NiO is a coloring component for coloring a glass with a desired gray color tone, and is an essential component in the first glass for chemical strengthening. In the first glass for chemical strengthening, when the content of NiO is less than 0.05%, a desired gray color tone in a glass cannot be obtained. Preferably, its content is 0.1% or more, more preferably 0.2% or more. In the first glass for chemical strengthening, when the content of NiO is more than 1%, brightness of the glass becomes excessively high, and a desired gray color tone cannot be obtained. Further, the glass becomes unstable and devitrification occurs. Preferably, its content is 0.9% or less, more preferably 0.8% or less.

Further, in the second glass for chemical strengthening, NiO is an essential component.

In the second glass for chemical strengthening, when the content of NiO is less than 0.01%, a desired gray color tone in a glass cannot be obtained. Preferably, its content is 0.03% or more, more preferably 0.07% or more. In the second glass for chemical strengthening, when the content of NiO is more than 1%, brightness of the glass becomes excessively high, and a desired gray color tone cannot be obtained. Further, the glass becomes unstable and devitrification occurs. Preferably, its content is 0.9% or less, more preferably 0.8% or less.

(SiO₂+Al₂O₃+B₂O₃)/(ΣR′₂O+CaO+SrO+BaO+Fe₂O₃+Co₃O₄) represents the ratio of the total content of reticulate oxides forming the network of the glass and the total content of a main modified oxide. Note that ΣR′₂O represents the total amount of all R′₂O components, that is, “Na₂O+K₂O+Li₂O”. When this ratio is less than 3, it is possible that the probability of breakage when an indentation is made after the chemical strengthening becomes large. Preferably, the ratio is 3.6 or more, typically 4 or more. When this ratio is more than 6, viscosity of the glass increases, and meltability of the glass decreases. Preferably, the ratio is 5.5 or less, more preferably 5 or less.

SO₃ is a component that operates as a refining agent, and is not essential but can be contained as necessary. When SO₃ is contained, an expected refining operation cannot be obtained if its content is less than 0.005%. Preferably, its content is 0.01% or more, more preferably 0.02% or more. Most preferably, its content is 0.03% or more. Further, when its content is more than 0.5%, it inversely becomes a source of bubbles, and it is possible that melting down of the glass becomes slow or the number of bubbles increases. Preferably, its content is 0.3% or less, more preferably 0.2% or less. Most preferably, its content is 0.1% or less.

SnO₂ is a component that operates as a refining agent, and is not essential but can be contained as necessary. When SnO₂ is contained, an expected refining operation cannot be obtained if its content is less than 0.005%. Preferably, its content is 0.01% or more, more preferably 0.05% or more. Further, when its content is more than 1%, it inversely becomes a source of bubbles, and it is possible that melting down of the glass becomes slow or the number of bubbles increases. Preferably, its content is 0.8% or less, more preferably 0.5% or less. Most preferably, its content is 0.3% or less.

TiO₂ is a component that improves weather resistance and adjusts the color tone of the glass to correct the color, and is not essential but can be contained as necessary. When TiO₂ is contained, a sufficient color correcting effect cannot be obtained if its content is less than 0.1%, and it is possible that a gray-based glass cannot be prevented sufficiently from exhibiting a bluish gray or brownish gray color. It is also possible that a significant effect cannot be obtained regarding improvement of weather resistance. Preferably, its content is 0.15% or more, typically 0.2% or more. When the content of TiO₂ is more than 1%, it is possible that the glass becomes unstable and devitrification occurs. Preferably, its content is 0.8% or less, typically 0.6% or less.

CuO is a component that adjusts the color tone of a glass to correct the color, and is not essential but can be contained as necessary. Further, CuO has an effect to lower metamerism when it is contained in a glass.

By containing CuO, the glass for chemical strengthening of the present invention can easily make an absolute value of Δa* defined by the following expression (I) and an absolute value of Δb* defined by the following expression (II) both be 2 or less. This can reduce the difference between a reflected color tone of the glass indoors and a reflected color tone of the glass outdoors.

(i) a difference Δa* between chromaticity a* of reflected light by a D65 light source and chromaticity a* of reflected light by an F2 light source in an L*a*b* color system

Δa*=a* value (D65 light source)−a* value (F2 light source) (I)

(ii) a difference Δb* between chromaticity b* of reflected light by a D65 light source and chromaticity b* of reflected light by an F2 light source in an L*a*b* color system

Δb*=b* value (D65 light source)−b* value (F2 light source) (II)

When CuO is contained, if its content is less than 0.05%, it is possible that a significant effect cannot be obtained regarding adjustment of color tone or suppression of metamerism. Preferably, its content is 0.2% or more, typically, 0.5% or more. When the content of CuO is more than 3%, it is possible that the glass becomes unstable and devitrification occurs. Preferably, its content is 2.5% or less, typically 2% or less.

Note that regarding Fe₂O₃, when it is contained in the glass, there is an effect to reduce the metamerism similarly to CuO. The content of Fe₂O₃ by which the significant effect regarding the metamerism can be obtained is preferably 0.05% to 2%, typically 0.3% to 1.5%.

Li₂O is a component for improving meltability, and is not essential but can be contained as necessary. When Li₂O is contained, it is possible that a significant effect cannot be obtained regarding improvement of meltability if its content is less than 1%. Preferably, its content is 3% or more, typically 6% or more. When the content of Li₂O is more than 15%, it is possible that weather resistance decreases. Preferably, its content is 10% or less, typically 5% or less.

SrO is a component for improving meltability, and is not essential but can be contained as necessary. When SrO is contained, it is possible that a significant effect cannot be obtained regarding improvement of meltability if its content is less than 1%. Preferably, its content is 3% or more, typically 6% or more. When the content of SrO is more than 15%, it is possible that weather resistance and chemical strengthening characteristic decrease. Preferably, its content is 12% or less, typically 9% or less.

BaO is a component for improving meltability, and is not essential but can be contained as necessary. When BaO is contained, it is possible that a significant effect cannot be obtained regarding improvement of meltability if its content is less than 1%. Preferably, its content is 3% or more, typically 6% or more. When the content of BaO is more than 15%, it is possible that weather resistance and chemical strengthening characteristic decrease. Preferably, its content is 12% or less, typically 9% or less.

ZnO is a component for improving meltability, and is not essential but can be contained as necessary. When ZnO is contained, it is possible that a significant effect cannot be obtained regarding improvement of meltability if its content is less than 1%. Preferably, its content is 3% or more, typically 6% or more. When the content of ZnO is more than 15%, it is possible that weather resistance decreases. Preferably, its content is 12% or less, typically 9% or less.

CeO₂, Er₂O₃, Nd₂O₃, MnO₂ and SeO₂ are color correcting components for adjusting the color tone of the glass, and are not essential but can be contained as necessary.

When these color correcting components are contained, if each content of them is less than 0.005% the effect of adjustment of color tone, that is, color correction cannot be obtained sufficiently, and it is possible that exhibition of, for example, bluish gray or brownish gray color tone cannot be prevented sufficiently. Each content of these color correcting components is preferably 0.05% or more, typically 0.1% or more. When each content of the color correcting components is more than 2%, it is possible that the glass becomes unstable and devitrification occurs. Typically, its content is 1.5% or less.

Note that the type and amount of the above-described color correcting components can be appropriately selected and used depending on the component to be the parent component of each glass.

As the above-described color correcting components, it is preferred that the total content of TiO₂, CuO, Cu₂O, CeO₂, Er₂O₃, Nd₂O₃, MnO₂ and SeO₂ be 0.005% to 3%, and it is preferred that the total content of CeO₂, Er₂O₃, Nd₂O₃, MnO₂ and SeO₂ be 0.005% to 2%.

By having the content of the color correcting components in the above-described range, a sufficient color correcting effect can be obtained, and a stable glass can be obtained.

In the glass for chemical strengthening of the present invention, Co is a coloring component and is also a refining agent. As the refining agent of the glass, SO₃ or SnO₂ may be used as necessary, but Sb₂O₃, Cl, F, and another component may be contained within the range not impairing the object of the present invention. When such a component is contained, it is preferred that the total content of these components be 1% or less, typically 0.5% or less. Note that As₂O₃ is an environment-affecting substance with which inverse effects to the environment are concerned not only in manufacturing processes but through the lifecycle of the product, and hence is not contained.

Note that the method for chemical strengthening the glass for chemical strengthening of the present invention is not particularly limited as long as it is able to exchange ions between Na₂O of the glass surface and K₂O in a molten salt, but typically a method which will be described later can be applied.

In the glass for chemical strengthening of the present invention, preferably, an absolute value of Δa* defined by the following expression (I) and an absolute value of Δb* defined by the following expression (II) are both 2 or less. This can reduce the metamerism and decrease the difference between a reflected color tone of the glass indoors and a reflected color tone of the glass outdoors.

(i) a difference Δa* between chromaticity a* of reflected light by a D65 light source and chromaticity a* of reflected light by an F2 light source in an L*a*b* color system

Δa*=a* value (D65 light source)−a* value (F2 light source) (I)

(ii) a difference Δb* between chromaticity b* of reflected light by a D65 light source and chromaticity b* of reflected light by an F2 light source in an L*a*b* color system

Δb*=b* value (D65 light source)−b* value (F2 light source) (II)

In order to reduce the metamerism, Δa* and Δb* in the glass for chemical strengthening are preferably both 1.5 or less in absolute value, more preferably both 1.2 or less in absolute value.

Further, in the glass for chemical strengthening of the present invention, the minimum value of the absorption coefficient at wavelengths of 380 nm to 780 nm is preferred to be 1 mm⁻¹ or more. The light source of a display device provided inside an electronic device is constituted of one emitting white light such as a light emitting diode, an organic EL, or CCFL. Thus, when the glass for chemical strengthening of the present invention is used as the housing of an electronic device, it is necessary to make the minimum value of the absorption coefficient at wavelengths of 380 nm to 780 nm be 1 mm⁻¹ or more in the glass so that the white light does not leak to the outside of the device via the glass. The white light is to be recognized as white color by combining light of plural wavelengths in the visible range using a fluorescent material. Accordingly, by making the minimum value of the absorption coefficient at the wavelengths of a visible range of the glass be 1 mm⁻¹ or more, the white light is absorbed solely by the glass without separately providing light blocking means, and thus a sufficient light blocking effect as a glass is obtained.

When the minimum value of the absorption coefficient at wavelengths of 380 nm to 780 nm of the glass is less than 1 mm⁻¹, even when it is a glass having a sufficient thickness for housing purposes, a desired light blocking effect cannot be obtained, and it is possible that light transmits the glass. Further, when the glass is formed in a concave shape or convex shape, light may transmit a position where the thickness is smallest. When the thickness of the glass is small, the minimum value of the absorption coefficient at wavelengths of 380 nm to 780 nm of the glass is preferred to be 2 mm⁻¹ or more, more preferably 3 mm⁻¹ or more, furthermore preferably 4 mm⁻¹ or more.

The method for calculating the absorption coefficient in the present invention is as follows. Both surfaces of a glass plate are mirror polished, and a thickness t is measured. Spectral transmittance T of this glass plate is measured (for example, an ultraviolet, visible, and near-infrared spectrophotometer V-570 made by JASCO Corporation is used). Then an absorption coefficient 13 is calculated using the relational expression T=10^{-βt}.

Further, in the glass for chemical strengthening of the present invention, a relative value of an absorption coefficient at a wavelength of 550 nm to an absorption coefficient at a wavelength of 600 nm (hereinafter, this relative value of the absorption coefficients may also be described as “the absorption coefficient at a wavelength of 550 nm/the absorption coefficient at a wavelength of 600 nm”) calculated from a spectral transmittance curve and a relative value of an absorption coefficient at a wavelength of 450 nm to an absorption coefficient at a wavelength of 600 nm (hereinafter, this relative value of the absorption coefficients may also be described as “the absorption coefficient at a wavelength of 450 nm/the absorption coefficient at a wavelength of 600 nm”) calculated from a spectral transmittance curve are both preferred to be within a range of 0.7 to 1.2. As described above, by selecting and blending Co₃O₄, NiO, Fe₂O₃ as coloring components, a glass exhibiting a gray color tone can be obtained. However, depending on the blending amounts of the respective coloring components, although it is gray, it may become brownish or bluish for example. To represent a desired gray color tone which does not appear to be another color on a glass, a glass in which a variation in absorption coefficient in the wavelength of visible light is small, that is, a glass which averagely absorbs light in the visible range is preferred.

Thus, the range of the relative values of absorption coefficients is preferred to be within the range of 0.7 to 1.2. When this range is smaller than 0.7, it is possible that the glass becomes bluish gray. On the other hand, when this range is larger than 1.2, it is possible that the glass becomes brownish or greenish gray.

Note that regarding the relative values of the absorption coefficients, when the absorption coefficient at a wavelength of 450 nm/the absorption coefficient at a wavelength of 600 nm and the absorption coefficient at a wavelength of 550 nm/the absorption coefficient at a wavelength of 600 nm both fall within the above-described range, this means that a glass having a gray color tone which does not appear to be another color can be obtained.

Further, in the glass for chemical strengthening of the present invention, preferably, variation amounts ΔT (550/600) and ΔT (450/600) of relative values of absorption coefficients represented by following expressions (1) and (2) are 5% or less in absolute value.

ΔT(550/600)(%)=[{A(550/600)−B(550/600)}/A(550/600)]×100 (1)

ΔT(450/600)(%)=[{A(450/600)−B(450/600)}/A(450/600)]×100 (2)

In the above expression (1), A(550/600) is a relative value of an absorption coefficient at a wavelength of 550 nm to an absorption coefficient at a wavelength of 600 nm, as calculated from a spectral transmittance curve of the glass after irradiation with light of a 400 W high-pressure mercury lamp for 100 hours, and B(550/600) is a relative value of an absorption coefficient at a wavelength of 550 nm to an absorption coefficient at a wavelength of 600 nm, as calculated from a spectral transmittance curve of the glass before the light irradiation.

In the above expression (2), A(450/600) is a relative value of an absorption coefficient at a wavelength of 450 nm to an absorption coefficient at a wavelength of 600 nm, as calculated from a spectral transmittance curve of the glass after irradiation with light of a 400 W high-pressure mercury lamp for 100 hours, and B(450/600) is a relative value of an absorption coefficient at a wavelength of 450 nm to an absorption coefficient at a wavelength of 600 nm, as calculated from a spectral transmittance curve of the glass before the light irradiation.

Note that “B(550/600)” in the above expression (1) and “the absorption coefficient at a wavelength of 550 nm/the absorption coefficient at a wavelength of 600 nm” have the same meaning, and the “B(450/600)” in the above expression (2) and “the absorption coefficient at a wavelength of 450 nm/the absorption coefficient at a wavelength of 600 nm” have the same meaning.

By the variation amounts ΔT (550/600) and ΔT (450/600) of the relative values of the absorption coefficients (“the absorption coefficient at a wavelength of 550 nm/the absorption coefficient at a wavelength of 600 nm” and “the absorption coefficient at a wavelength of 450 nm/the absorption coefficient at a wavelength of 600 nm”) represented by the above-described expression (1) and expression (2) being both within the above-described range, variation in absorption characteristic with respect to light at a wavelength of the visible range before and after irradiation of light can be suppressed, and it can be made as a glass in which variation in color tone is suppressed for a long period.

Specifically, in the above expression (1), A(550/600) is a relative value of an absorption coefficient at a wavelength of 550 nm to an absorption coefficient at a wavelength of 600 nm, as calculated from a spectral transmittance curve of the glass after being irradiated with light of a 400 W high pressure mercury lamp for 100 hours from a separation distance of 15 cm to a polished surface of a glass having a thickness of 0.8 mm, which is optically mirror polished on both surfaces, and B(550/600) is a relative value of an absorption coefficient at a wavelength of 550 nm to an absorption coefficient at a wavelength of 600 nm, as calculated from a spectral transmittance curve of the glass before the light irradiation.

In the above expression (2), A(450/600) is a relative value of an absorption coefficient at a wavelength of 450 nm to an absorption coefficient at a wavelength of 600 nm, as calculated from a spectral transmittance curve of the glass after irradiation with light of a 400 W high-pressure mercury lamp for 100 hours from a separation distance of 15 cm to a polished surface of a glass having a thickness of 0.8 mm, which is optically mirror polished on both surfaces, and B(450/600) is a relative value of an absorption coefficient at a wavelength of 450 nm to an absorption coefficient at a wavelength of 600 nm, as calculated from a spectral transmittance curve of the glass before the light irradiation.

Further, in the glass for chemical strengthening of the present invention, a minimum value of absorbance at wavelengths of 380 nm to 780 nm is preferred to be 0.7 or more.

The light source of a display device provided inside an electronic device is constituted of one emitting white light such as a light emitting diode, an organic EL, or CCFL. Thus, when the glass for chemical strengthening of the present invention is used as the housing of an electronic device, it is necessary to make the minimum value of absorbance at wavelengths of 380 nm to 780 nm be 0.7 or more so that the white light does not leak to the outside of the device via the glass. The white light is to be recognized as white color by combining light of plural wavelengths in the visible range using a fluorescent material. Accordingly, by making the absorbance at the wavelengths of a visible range of the glass be 0.7 or more, the white light is absorbed solely by the glass without separately providing light blocking means, and thus a sufficient light blocking effect as a glass is obtained.

When the minimum value of the absorbance at wavelengths of 380 nm to 780 nm of the glass is less than 0.7, even when it is a glass having a sufficient thickness for housing purposes, a desired light blocking effect cannot be obtained, and it is possible that light transmits the glass. Further, when the glass is formed in a concave shape or convex shape, light may transmit a position where the thickness is smallest. The minimum value of the absorbance at wavelengths of 380 nm to 780 nm of the glass is preferred to be 0.9 or more, more preferably 1.2 or more, furthermore preferably 1.5 or more.

The method for calculating the absorbance in the present invention is as follows. Both surfaces of a glass plate are mirror polished, and a thickness t is measured. Spectral transmittance T of this glass plate is measured (for example, an ultraviolet, visible, and near-infrared spectrophotometer V-570 made by JASCO Corporation is used). Then absorbance A is calculated using the relational expression A=−log₁₀ T.

Further, the glass for chemical strengthening of the present invention is preferred to have radio wave transparency. For example, in the case where the glass for chemical strengthening is applied as the housing of a portable phone or the like which includes a communication element in the device and performs transmission or reception of information using radio waves, when this glass for chemical strengthening has radio wave transparency, decrease in communication sensitivity due to the presence of the glass is suppressed. Regarding the radio wave transparency in the glass for chemical strengthening of the present invention, the maximum value of a dielectric loss tangent (tan δ) in the frequency range of 50 MHz to 3.0 GHz is preferred to be 0.02 or less. Preferably, the maximum value of tan δ is 0.015 or less, more preferably 0.01 or less.

A manufacturing method of the glass for chemical strengthening of the present invention is not particularly limited. For example, appropriate amounts of various materials are blended, heated to about 1500° C. to about 1600° C. and melted, thereafter made uniform by defoaming, stirring, or the like, and formed in a plate shape or the like by a known down-draw method, press method, or the like, or casted and formed in a block shape. Then, by cutting into a desired size after annealing, and polishing as necessary, the first glass for chemical strengthening containing, in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (where R represents Mg, Ca, Sr, Ba, or Zn), 0.01% to 0.2% of Co₃O₄, 0.05% to 1% of NiO, and 0.005% to 3% of Fe₂O₃ is manufactured.

The manufacturing method of the first glass for chemical strengthening of the present invention allows manufacturing the glasses for chemical strengthening according to the above-described embodiments.

Specifically, for example, by the manufacturing method of the first glass for chemical strengthening of the present invention, the glass for chemical strengthening according to the above-described first embodiment, that is, the glass for chemical strengthening containing, in mole percentage based on following oxides, 55% to 80% of SiO₂, 3% to 16% of Al₂O₃, 0% to 12% of B₂O₃, 5% to 16% of Na₂O, 0% to 15% of K₂O, 0% to 15% of MgO, 0% to 3% of CaO, 0% to 18% of ΣRO (where R represents Mg, Ca, Sr, Ba, or Zn), 0.01% to 0.2% of Co₃O₄, 0.05% to 1% of NiO, and 0.005% to 3% of Fe₂O₃, can be manufactured.
Further, by the manufacturing method of the first glass for chemical strengthening of the present invention, the glass for chemical strengthening according to the above-described second embodiment, that is, the glass for chemical strengthening containing, in mole percentage based on following oxides, 55% to 80% of SiO₂, 0.25% to 5% of Al₂O₃, 0% to 12% of B₂O₃, 5% to 20% of Na₂O, 0% to 8% of K₂O, 0% to 15% of MgO, 5% to 15% of CaO, 5% to 25% of ΣRO (where R represents Mg, Ca, Sr, Ba, or Zn), 0.01% to 0.2% of Co₃O₄, 0.05% to 1% of NiO, and 0.005% to 3% of Fe₂O₃, can be manufactured.

Further, a manufacturing method of the glass for chemical strengthening of the present invention is not particularly limited. For example, appropriate amounts of various materials are blended, heated to about 1500° C. to about 1600° C. and melted, thereafter made uniform by defoaming, stirring, or the like, and formed in a plate shape or the like by a known down-draw method, press method, or the like, or casted and formed in a block shape. Then, by cutting into a desired size after annealing, and polishing as necessary, a second glass for chemical strengthening containing, in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃ is manufactured.

The manufacturing method of the second glass for chemical strengthening of the present invention allows manufacturing the glasses for chemical strengthening according to the above-described embodiments.

Specifically, for example, by the manufacturing method of the second glass for chemical strengthening of the present invention, the glass for chemical strengthening according to the above-described first embodiment, that is, the glass for chemical strengthening containing, in mole percentage based on following oxides, 55% to 80% of SiO₂, 3% to 16% of Al₂O₃, 0% to 12% of B₂O₃, 5% to 16% of Na₂O, 0% to 15% of K₂O, 0% to 15% of MgO, 0% to 3% of CaO, 0% to 18% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃, can be manufactured.
Further, by the manufacturing method of the second glass for chemical strengthening of the present invention, the glass for chemical strengthening according to the above-described second embodiment, that is, the glass for chemical strengthening containing, in mole percentage based on following oxides, 55% to 80% of SiO₂, 0.25% to 5% of Al₂O₃, 0% to 12% of B₂O₃, 5% to 20% of Na₂O, 0% to 8% of K₂O, 0% to 15% of MgO, 5% to 15% of CaO, 5% to 25% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃, can be manufactured.

The method for chemical strengthening is not particularly limited as long as it is able to exchange ions between Na₂O in the glass surface layer and K₂O in a molten salt. For example, there is a method to immerse the glass in a heated potassium nitrate (KNO₃) molten salt. The condition for forming a chemical strengthened layer (surface compressive stress layer) having a desired surface compressive stress on the glass surface is, typically, immersing a glass in a KNO₃ molten salt at 400° C. to 550° C. for 2 to 20 hours, although it differs depending on the thickness of the glass.

Further, this KNO₃ molten salt may be one containing, for example, about 5% or less NaNO₃ besides the KNO₃.

The glass for chemical strengthening of the present invention is formed in a desired shape by the above-described manufacturing method. Further, to the glass for chemical strengthening of the present invention, for example after it is formed in the desired shape, the above-described method of chemical strengthening can be applied to produce a chemical strengthened glass. At this time, the depth of the surface compressive stress layer formed by the chemical strengthening is 5 μm to 70 μm.

That is, a chemical strengthened glass of the present invention is a chemical strengthened glass obtained by chemical strengthening the glass for chemical strengthening according to the above-described embodiments by the above-described method of chemical strengthening.

In the chemical strengthened glass of the present invention, preferably, a depth of the surface compressive stress layer formed in a surface of the chemical strengthened glass by the chemical strengthening is 5 μm to 70 μm. The depth of such a surface compressive stress layer is more preferably 6 μm to 70 μm. The reason of this is as follows.

In manufacturing of glasses used for decorative purposes, the surface of a glass may be polished, and the grain diameter of abrasive grain used for polishing in the final stage thereof is typically 2 μm to 6 μm. By such abrasive grain, in the glass surface, it is conceivable that a micro-crack of 5 μm at most is finally formed. To make the strength improving effect by chemical strengthening be effective, it is necessary that a surface compressive stress layer deeper than the micro-crack formed in the glass surface is formed. Accordingly, the depth of the surface compressive stress layer formed due to chemical strengthening is preferably 6 μm or more. Further, a scratch beyond the depth of the surface compressive stress layer being made when in use leads to breakage of the glass, and thus the surface compressive stress layer is preferred to be thick. Accordingly, the depth of the surface compressive stress layer is more preferably 10 μm or more, furthermore preferably 20 μm or more, typically 30 μm or more.

On a soda lime glass, by chemical strengthening by applying the above-described chemical strengthening method, the surface compressive stress of the surface compressive stress layer formed on the glass surface can be 300 MPa or more, but it is not easy to form the depth of the surface compressive stress layer to be 30 μm or more. The first glass for chemical strengthening and the second glass for chemical strengthening according to the present invention allow forming the surface compressive stress layer having a depth of 30 μm or more by chemical strengthening.

On the other hand, when the surface compressive stress layer is too deep, the internal tensile stress becomes large, and the impact at the time of breakage becomes large. Specifically, when the internal tensile stress is large, it is known that the glass tends to be small pieces and scatters when it breaks, making it more hazardous. As a result of experiment by the present inventors, it was found that in a glass having a thickness of 2 mm or less, when the depth of the surface compressive stress layer is more than 70 μm, scattering at the time of breakage becomes significant. Therefore, in the chemical strengthened glass of the present invention, the depth of the surface compressive stress layer is 70 μm or less. When it is used as a glass for decoration, although depending on its purpose, for example, when it is applied to a purpose such as a portable device having a high probability of receiving a contact scratch on its surface, it is conceivable to make the depth of the surface compressive stress layer thin in view of safety, as compared to an operating panel of a mounting type apparatus such as audiovisual apparatus or office automation apparatus. In this case, the depth of the surface compressive stress layer is more preferably 60 μm or less, furthermore preferably 50 μm or less, typically 40 μm or less.

Further, the glass for chemical strengthening of the present invention allows obtaining a chemical strengthened glass by performing chemical strengthening as described above. In the chemical strengthened glass of the present invention obtained in this manner, the surface compressive stress of the surface compressive stress layer formed on the glass surface is 300 MPa or more, preferably 550 MPa or more, more preferably 700 MPa or more. Further, the surface compressive stress of the surface compressive stress layer is preferably 1400 MPa or less, more preferably 1300 MPa or less. It is typically 1200 MPa or less.

The glass for chemical strengthening of the present invention allows forming the surface compressive stress layer having surface compressive stress of 300 MPa or more on the glass surface by performing chemical strengthening.

The chemical strengthened glass of the present invention is a chemical strengthened glass obtained by chemical strengthening in which, preferably, an absolute value of Δa* defined by the following expression (I) and an absolute value of Δb* defined by the following expression (II) are both 2 or less. This can reduce the metamerism and decrease the difference between a reflected color tone of the glass indoors and a reflected color tone of the glass outdoors.

(i) a difference Δa* between chromaticity a* of reflected light by a D65 light source and chromaticity a* of reflected light by an F2 light source in an L*a*b* color system

Δa*=a* value (D65 light source)−a* value (F2 light source) (I)

(ii) a difference Δb* between chromaticity b* of reflected light by a D65 light source and chromaticity b* of reflected light by an F2 light source in an L*a*b* color system

Δb*=b* value (D65 light source)−b* value (F2 light source) (II)

In order to reduce the metamerism, Δa* and Δb* in the chemical strengthened glass are preferably both 1.5 or less in absolute value, more preferably both 1.2 or less in absolute value.

In the foregoing, the examples of the glass for chemical strengthening of the present invention have been described, but the formation can be appropriately changed as necessary within a limit that does not go against the spirit of the present invention.

### EXAMPLES

Hereinafter, the present invention will be described in detail based on examples, but the invention is not limited to these examples.

Regarding Examples 1 to 91 of Table 1 to Table 10 (Examples 1 to 62 and Examples 67 to 91 are working examples, Example 63 is a comparative example, and Example 64 to 66 are references), generally used glass materials such as oxides, hydroxides, carbonates, nitrate salts, and the like were selected appropriately and measured to be 100 ml as a glass so that they are in compositions expressed in mole percentage in the tables. Note that SO₃ described in the tables is residual SO₃ remaining in the glass after sodium sulfate (Na₂SO₄) is added to the glass materials and after the sodium sulfate is decomposed, and is a calculated value.

Next, this material mixture was put into a melting pot made of platinum, placed in a resistance-heating electric furnace at 1500° C. to 1600° C., and after heated for about 0.5 hour and the materials were melted down, it was melted for one hour to defoam. Thereafter, it was poured into a mold material preheated to approximately 630° C., which is about 50 mm length, about 100 mm width, and about 20 mm high, and annealed at the rate of about 1° C./min, thereby obtaining a glass block. This glass block was cut, and after the glass was cut out so that it has a size of 40 mm×40 mm and a thickness as illustrated in Tables 1 to 10, it was grinded and finally mirror polished on both surfaces, thereby obtaining a plate-shaped glass.

For the plate-shaped glass obtained, the minimum value of the absorption coefficient at wavelengths of 380 nm to 780 nm, relative values of absorption coefficients (an absorption coefficient at a wavelength of 550 nm/an absorption coefficient at a wavelength of 600 nm and an absorption coefficient at a wavelength of 450 nm/an absorption coefficient at a wavelength of 600 nm), a minimum value of absorbance at wavelengths of 380 nm to 780 nm, and glass thickness t are described together in Tables 1 to 10.

In Tables 1 to 10, “@550 nm/@600 nm” represents “the absorption coefficient at a wavelength of 550 nm/the absorption coefficient at a wavelength of 600 nm”, and “@450 nm/@600 nm” represents “the absorption coefficient at a wavelength of 450 nm/the absorption coefficient at a wavelength of 600 nm”.
Note that “-” in Tables 1 to 10 represents that it is not measured.
Further, in Tables 1 to 10, regarding ones having a thickness of a glass described by “-”, the cutting, grinding, and mirror polishing of the above-described glass block were performed so that the thickness after the mirror polishing becomes 0.8 mm.

TABLE 1

| | Example | Example | Example | Example | Example | Example | Example | Example | Example |
|---|---|---|---|---|---|---|---|---|---|
| [mol %] | 1 | 2 | 3 | 4 | 5 | 6 | 7 | 8 | 9 |
| SiO₂ | 63.8 | 64.0 | 63.7 | 63.5 | 63.5 | 63.4 | 63.7 | 63.8 | 63.2 |
| Na₂O | 12.4 | 12.4 | 12.4 | 12.4 | 12.3 | 12.3 | 12.4 | 12.4 | 12.3 |
| K₂O | 4.0 | 4.0 | 4.0 | 4.0 | 4.0 | 3.9 | 4.0 | 4.0 | 3.9 |
| MgO | 0 | 10.6 | 10.4 | 10.4 | 10.4 | 10.4 | 10.4 | 10.4 | 10.3 |
| CaO | 0 | 0 | 0 | 0 | 0 | 0 | 0 | 0 | 0 |
| BaO | 0 | 0 | 0 | 0 | 0 | 0 | 0 | 0 | 0 |
| SrO | 0 | 0 | 0 | 0 | 0 | 0 | 0 | 0 | 0 |
| Al₂O₃ | 7.9 | 8.0 | 7.9 | 7.9 | 7.9 | 7.9 | 7.9 | 7.9 | 7.9 |
| TiO₂ | 0 | 0 | 0.25 | 0 | 0 | 0 | 0.5 | 0.25 | 0.25 |
| ZrO₂ | 0.5 | 0.5 | 0.5 | 0.5 | 0.5 | 0.5 | 0.5 | 0.4 | 0.5 |
| CeO₂ | 0 | 0 | 0 | 0 | 0 | 0 | 0 | 0 | 0 |
| CoO (Co₃O₄) | 0.07 | 0.07 | 0.06 | 0.04 | 0.04 | 0.04 | 0.06 | 0.05 | 0.05 |
| Fe₂O₃ | 0.015 | 0.02 | 0.018 | 1.14 | 1.14 | 1.13 | 0.01 | 0.018 | 1.03 |
| Er₂O₃ | 0 | 0 | 0 | 0 | 0 | 0 | 0 | 0 | 0 |
| Nd₂O₃ | 0 | 0 | 0 | 0 | 0 | 0 | 0 | 0 | 0 |
| SO₃ | 0.1 | 0.1 | 0.1 | 0.1 | 0.1 | 0.1 | 0.1 | 0.1 | 0.1 |
| NiO | 0.75 | 0.5 | 0.74 | 0.1 | 0.2 | 0.3 | 0.5 | 0.65 | 0.44 |
| MnO₂ | 0 | 0 | 0 | 0 | 0 | 0 | 0 | 0 | 0 |
| CuO | 0 | 0 | 0 | 0 | 0 | 0 | 0 | 0 | 0 |
| Co₃O₄/Fe₂O₃ | 4.67 | 3.50 | 3.33 | 0.04 | 0.04 | 0.04 | 6.00 | 2.78 | 0.05 |
| (SiO₂ + Al₂O₃ + B₂O₃)/ | 4.36 | 4.36 | 4.36 | 4.09 | 4.09 | 409 | 4.36 | 4.36 | 4.11 |
| (ΣR′₂O + CaO + SrO + BaO + | | | | | | | | | |
| Co₃O₄ + Fe₂O₃) | | | | | | | | | |
| Absorption coefficient [mm⁻¹] | 0.096 | 0.076 | 0.088 | 0.337 | 0.357 | 0.361 | 0.083 | 0.090 | 0.350 |
| (Minimum value at wavelengths of | | | | | | | | | |
| 380 nm to 780 nm) | | | | | | | | | |
| Relative value of absorption | 0.771 | 0.701 | 0.813 | 0.667 | 0.720 | 0.757 | 0.739 | 0.817 | 0.794 |
| coefficient (@550 nm/@600 nm) | | | | | | | | | |
| Relative value of absorption | 0.857 | 0.654 | 0.956 | 0.668 | 0.824 | 0.944 | 0.752 | 0.933 | 0.966 |
| coefficient (@450 nm/@600 nm) | | | | | | | | | |
| Plate thickness (mm) | 7.4 | 9.4 | 8.4 | 2.1 | 3.1 | 2.9 | 9.1 | 8.0 | 3.2 |
| Absorbance | 0.71 | 0.72 | 0.74 | 0.80 | 1.11 | 1.04 | 0.75 | 0.72 | 1.11 |
| (Minimum value at wavelengths of | | | | | | | | | |
| 380 nm to 780 nm) | | | | | | | | | |

TABLE 2

| | Example | Example | Example | Example | Example | Example | Example | Example | Example |
|---|---|---|---|---|---|---|---|---|---|
| [mol %] | 10 | 11 | 12 | 13 | 14 | 15 | 16 | 17 | 18 |
| SiO₂ | 63.0 | 63.2 | 64.8 | 63.3 | 63.4 | 63.5 | 64.1 | 64.4 | 65.0 |
| Na₂O | 12.3 | 12.3 | 13.8 | 12.3 | 12.8 | 12.3 | 13.6 | 13.7 | 13.8 |
| K₂O | 3.9 | 3.9 | 3.9 | 3.9 | 3.9 | 4.0 | 3.9 | 3.9 | 4.0 |
| MgO | 10.3 | 10.3 | 7.4 | 10.3 | 9.3 | 10.4 | 7.3 | 7.3 | 7.4 |
| CaO | 0 | 0 | 0 | 0 | 0 | 0 | 0 | 0 | 0 |
| BaO | 0 | 0 | 0 | 0 | 0 | 0 | 0 | 0 | 0 |
| SrO | 0 | 0 | 0 | 0 | 0 | 0 | 0 | 0 | 0 |
| Al₂O₃ | 7.8 | 7.9 | 7.9 | 7.9 | 7.9 | 7.9 | 7.8 | 7.8 | 7.9 |
| TiO₂ | 0.73 | 0.49 | 0.25 | 0.25 | 0.25 | 0.25 | 0.24 | 0.24 | 0.25 |
| ZrO₂ | 0.5 | 0.5 | 0.4 | 0.5 | 0.4 | 0.4 | 0.4 | 0.4 | 0.4 |
| CeO₂ | 0 | 0 | 0 | 0 | 0 | 0 | 0 | 0 | 0 |
| CoO (Co₃O₄) | 0.06 | 0.06 | 0.06 | 0.06 | 0.04 | 0.05 | 0.05 | 0.05 | 0.05 |
| Fe₂O₃ | 1.03 | 1.03 | 1.03 | 1.03 | 0.025 | 0.015 | 0.02 | 0.01 | 0.025 |
| Er₂O₃ | 0 | 0 | 0 | 0 | 0 | 0 | 0 | 0 | 0 |
| Nd₂O₃ | 0 | 0 | 0 | 0 | 0 | 0 | 0 | 0 | 0 |
| SO₃ | 0.1 | 0.1 | 0.1 | 0.1 | 0.1 | 0.1 | 0.1 | 0.1 | 0.1 |
| NiO | 0.29 | 0.25 | 0.34 | 0.3 | 0.61 | 0.65 | 0.54 | 0.54 | 0.55 |
| MnO₂ | 0 | 0 | 0 | 0 | 0 | 0 | 0 | 0 | 0 |
| CuO | 0 | 0 | 0 | 0 | 0.98 | 0.49 | 1.95 | 1.47 | 0.59 |
| Co₃O₄/Fe₂O₃ | 0.06 | 0.06 | 0.06 | 0.06 | 1.60 | 3.33 | 2.50 | 5.00 | 2.00 |
| (SiO₂ + Al₂O₃ + B₂O₃)/ | 4.10 | 4.11 | 3.86 | 4.11 | 4.25 | 4.36 | 4.08 | 4.09 | 4.08 |
| (ΣR′₂O + CaO + SrO + BaO + | | | | | | | | | |
| Co₃O₄ + Fe₂O₃) | | | | | | | | | |
| Absorption coefficient [mm⁻¹] | 0.342 | 0.331 | 0.340 | 0.322 | 0.308 | 0.184 | 0.492 | 0.373 | 0.149 |
| (Minimum value at wavelengths of | | | | | | | | | |
| 380 nm to 780 nm) | | | | | | | | | |
| Relative value of absorption | 0.725 | 0.702 | 0.738 | 0.703 | 0.791 | 0.807 | 0.757 | 0.769 | 0.784 |
| coefficient (@550 nm/@600 nm) | | | | | | | | | |
| Relative value of absorption | 0.842 | 0.753 | 0.634 | 0.773 | 0.874 | 0.956 | 0.666 | 0.670 | 0.632 |
| coefficient (@450 nm/@600 nm) | | | | | | | | | |
| Plate thickness (mm) | 2.9 | 3.6 | 2.5 | 3.1 | 2.4 | 3.9 | 3.0 | 3.1 | 4.7 |
| Absorbance | 0.99 | 1.20 | 0.85 | 0.99 | 0.75 | 0.71 | 1.50 | 1.15 | 0.70 |
| (Minimum value at wavelengths of | | | | | | | | | |
| 380 nm to 780 nm) | | | | | | | | | |

TABLE 3

| | Example | Example | Example | Example | Example | Example | Example | Example | Example |
|---|---|---|---|---|---|---|---|---|---|
| [mol %] | 19 | 20 | 21 | 22 | 23 | 24 | 25 | 26 | 27 |
| SiO₂ | 62.6 | 63.2 | 64.8 | 64.7 | 64.1 | 63.4 | 63.7 | 63.1 | 63.4 |
| Na₂O | 12.2 | 12.3 | 13.8 | 13.8 | 13.6 | 12.5 | 12.8 | 12.3 | 12.3 |
| K₂O | 3.9 | 3.9 | 3.9 | 3.9 | 3.9 | 3.9 | 3.9 | 3.9 | 4.0 |
| MgO | 10.2 | 10.3 | 7.4 | 7.4 | 7.3 | 9.8 | 9.3 | 10.3 | 10.4 |
| CaO | 0 | 0 | 0 | 0 | 0 | 0 | 0 | 0 | 0 |
| BaO | 0 | 0 | 0 | 0 | 0 | 0 | 0 | 0 | 0 |
| SrO | 0 | 0 | 0 | 0 | 0 | 0 | 0 | 0 | 0 |
| Al₂O₃ | 7.8 | 7.9 | 7.9 | 7.9 | 7.8 | 7.9 | 7.9 | 7.9 | 7.9 |
| TiO₂ | 0.24 | 0.25 | 0.25 | 0.25 | 0.24 | 0.25 | 0.25 | 0.25 | 0.25 |
| ZrO₂ | 0.4 | 0.4 | 0.4 | 0.4 | 0.4 | 0.4 | 0.4 | 0.5 | 0.5 |
| CeO₂ | 0 | 0 | 0 | 0 | 0 | 0 | 0 | 0.98 | 0.49 |
| CoO (Co₃O₄) | 0.03 | 0.05 | 0.05 | 0.05 | 0.05 | 0.05 | 0.04 | 0.05 | 0.05 |
| Fe₂O₃ | 0.03 | 0.016 | 0.021 | 0.015 | 0.022 | 0.013 | 0.01 | 0.012 | 0.012 |
| Er₂O₃ | 0 | 0 | 0 | 0 | 0 | 0 | 0 | 0 | 0 |
| Nd₂O₃ | 0 | 0 | 0 | 0 | 0 | 0 | 0 | 0 | 0 |
| SO₃ | 0.1 | 0.1 | 0.1 | 0.1 | 0.1 | 0.1 | 0.1 | 0.1 | 0.1 |
| NiO | 0.54 | 0.64 | 0.55 | 0.64 | 0.54 | 0.63 | 0.62 | 0.64 | 0.65 |
| MnO₂ | 0 | 0 | 0 | 0 | 0 | 0 | 0 | 0 | 0 |
| CuO | 1.95 | 0.98 | 0.79 | 0.98 | 1.95 | 0.98 | 0.98 | 0 | 0 |
| Co₃O₄/Fe₂O₃ | 1.00 | 3.13 | 2.38 | 3.33 | 2.27 | 3.85 | 4.00 | 4.17 | 4.17 |
| (SiO₂ + Al₂O₃ + B₂O₃)/ | 4.36 | 4.36 | 4.08 | 4.09 | 4.08 | 4.31 | 4.27 | 4.36 | 4.36 |
| (ΣR′₂O + CaO + SrO + BaO + | | | | | | | | | |
| Co₃O₄ + Fe₂O₃) | | | | | | | | | |
| Absorption coefficient [mm⁻¹] | 0.717 | 0.349 | 0.188 | 0.247 | 0.543 | 0.325 | 0.307 | 0.125 | 0.121 |
| (Minimum value at wavelengths of | | | | | | | | | |
| 380 nm to 780 nm) | | | | | | | | | |
| Relative value of absorption | 0.774 | 0.771 | 0.779 | 0.797 | 0.745 | 0.779 | 0.801 | 0.821 | 0.816 |
| coefficient (@550 nm/@600 nm) | | | | | | | | | |
| Relative value of absorption | 0.992 | 0.901 | 0.626 | 0.696 | 0.649 | 0.888 | 0.902 | 1.046 | 1.014 |
| coefficient (@450 nm/@600 nm) | | | | | | | | | |
| Plate thickness (mm) | 1.7 | 3.1 | 4.5 | 3.6 | 2.1 | 2.3 | 3.3 | 3.1 | 2.9 |
| Absorbance | 1.23 | 1.08 | 0.84 | 0.89 | 1.14 | 0.75 | 1.02 | 1.11 | 1.04 |
| (Minimum value at wavelengths of | | | | | | | | | |
| 380 nm to 780 nm) | | | | | | | | | |

TABLE 4

| | Example | Example | Example | Example | Example | Example | Example | Example | Example |
|---|---|---|---|---|---|---|---|---|---|
| [mol %] | 28 | 29 | 30 | 31 | 32 | 33 | 34 | 35 | 36 |
| SiO₂ | 63.6 | 63.0 | 63.0 | 63.1 | 63.2 | 63.1 | 63.2 | 63.3 | 63.3 |
| Na₂O | 12.4 | 12.3 | 12.2 | 12.3 | 12.3 | 12.3 | 12.3 | 12.3 | 12.3 |
| K₂O | 4.0 | 3.9 | 3.9 | 3.9 | 3.9 | 3.9 | 3.9 | 3.9 | 3.9 |
| MgO | 10.4 | 10.3 | 10.3 | 10.3 | 10.3 | 10.3 | 10.3 | 10.3 | 10.3 |
| CaO | 0 | 0 | 0 | 0 | 0 | 0 | 0 | 0 | 0 |
| BaO | 0 | 0 | 0 | 0 | 0 | 0 | 0 | 0 | 0 |
| SrO | 0 | 0 | 0 | 0 | 0 | 0 | 0 | 0 | 0 |
| Al₂O₃ | 7.9 | 7.8 | 7.8 | 7.9 | 7.9 | 7.9 | 7.9 | 7.9 | 7.9 |
| TiO₂ | 0.25 | 0.25 | 0.24 | 0.25 | 0.25 | 0.25 | 0.25 | 0.25 | 0.25 |
| ZrO₂ | 0.5 | 0.5 | 0.5 | 0.5 | 0.5 | 0.5 | 0.5 | 0.5 | 0.5 |
| CeO₂ | 0.25 | 0 | 0 | 0 | 0 | 0 | 0 | 0 | 0 |
| CoO (Co₃O₄) | 0.05 | 0.06 | 0.06 | 0.06 | 0.06 | 0.06 | 0.06 | 0.06 | 0.06 |
| Fe₂O₃ | 0.02 | 1.03 | 1.03 | 1.03 | 1.03 | 1.03 | 1.03 | 1.03 | 1.03 |
| Er₂O₃ | 0 | 0.39 | 0 | 0 | 0 | 0 | 0 | 0 | 0 |
| NdO₃ | 0 | 0 | 0.49 | 0.25 | 0.12 | 0 | 0 | 0 | 0 |
| SO₃ | 0.1 | 0.1 | 0.1 | 0.1 | 0.1 | 0.1 | 0.1 | 0.1 | 0.1 |
| NiO | 0.65 | 0.34 | 0.34 | 0.34 | 0.34 | 0.34 | 0.34 | 0.34 | 0.34 |
| MnO₂ | 0 | 0 | 0 | 0 | 0 | 0.25 | 0.1 | 0.05 | 0.01 |
| CuO | 0 | 0 | 0 | 0 | 0 | 0 | 0 | 0 | 0 |
| Co₃O₄/Fe₂O₃ | 2.50 | 0.06 | 0.06 | 0.06 | 0.06 | 0.06 | 0.06 | 0.06 | 0.06 |
| (SiO₂ + Al₂O₃ + B₂O₃)/ | 4.36 | 4.11 | 4.10 | 4.10 | 4.11 | 4.10 | 4.11 | 4.11 | 4.11 |
| (ΣR′₂O + CaO + SrO + BaO + | | | | | | | | | |
| Co₃O₄ + Fe₂O₃) | | | | | | | | | |
| Absorption coefficient [mm⁻¹] | 0.115 | 0.347 | 0.348 | 0.346 | 0.356 | 0.340 | 0.339 | 0.342 | 0.349 |
| (Minimum value at wavelengths of | | | | | | | | | |
| 380 nm to 780 nm) | | | | | | | | | |
| Relative value of absorption | 0.825 | 0.735 | 0.690 | 0.707 | 0.716 | 0.746 | 0.744 | 0.722 | 0.734 |
| coefficient (@550 nm/@600 nm) | | | | | | | | | |
| Relative value of absorption | 1.005 | 0.850 | 0.810 | 0.825 | 0.822 | 0.849 | 0.831 | 0.827 | 0.830 |
| coefficient (@450 nm/@600 nm) | | | | | | | | | |
| Plate thickness (mm) | 6.3 | 2.8 | 2.7 | 2.9 | 2.5 | 2.8 | 2.9 | 2.9 | 2.5 |
| Absorbance | 0.73 | 0.97 | 0.94 | 1.01 | 0.89 | 0.96 | 0.97 | 0.99 | 0.87 |
| (Minimum value at wavelengths of | | | | | | | | | |
| 380 nm to 780 nm) | | | | | | | | | |

TABLE 5

| | Example | Example | Example | Example | Example | Example | Example | Example | Example |
|---|---|---|---|---|---|---|---|---|---|
| [mol %] | 37 | 38 | 39 | 40 | 41 | 42 | 43 | 44 | 45 |
| SiO₂ | 63.7 | 63.3 | 63.3 | 63.2 | 63.3 | 63.3 | 63.3 | 63.4 | 66.9 |
| Na₂O | 12.4 | 13.8 | 14.8 | 14.3 | 10.3 | 8.3 | 6.4 | 5.4 | 14.8 |
| K₂O | 4.0 | 3.9 | 3.9 | 3.9 | 5.9 | 7.8 | 9.8 | 11.3 | 0.01 |
| MgO | 10.4 | 8.9 | 7.9 | 8.4 | 10.3 | 10.3 | 10.3 | 10.3 | 5.7 |
| CaO | 0 | 0 | 0 | 0 | 0 | 0 | 0 | 0 | 0.1 |
| BaO | 0 | 0 | 0 | 0 | 0 | 0 | 0 | 0 | 0 |
| SrO | 0 | 0 | 0 | 0 | 0 | 0 | 0 | 0 | 0 |
| Al₂O₃ | 7.9 | 7.9 | 7.9 | 7.9 | 7.8 | 7.8 | 7.8 | 7.8 | 10.7 |
| TiO₂ | 0.25 | 0.25 | 0.25 | 0.25 | 0.24 | 0.24 | 0.24 | 0 | 0 |
| ZrO₂ | 0.5 | 0.4 | 0.4 | 0.4 | 0.4 | 0.4 | 0.4 | 0 | 0 |
| CeO₂ | 0 | 0 | 0 | 0 | 0 | 0 | 0 | 0 | 0 |
| CoO (Co₃O₄) | 0.04 | 0.05 | 0.05 | 0.06 | 0.05 | 0.05 | 0.05 | 0.05 | 0.05 |
| Fe₂O₃ | 0.25 | 0.98 | 0.98 | 0.98 | 0.010 | 0.021 | 0.015 | 0.022 | 0.011 |
| Er₂O₃ | 0 | 0 | 0 | 0 | 0 | 0 | 0 | 0 | 0 |
| Nd₂O₃ | 0 | 0 | 0 | 0 | 0 | 0 | 0 | 0 | 0 |
| SO₃ | 0.1 | 0.1 | 0.1 | 0.1 | 0.1 | 0.1 | 0.1 | 0.1 | 0.1 |
| NiO | 0.46 | 0.46 | 0.46 | 0.54 | 0.64 | 0.64 | 0.64 | 0.64 | 0.64 |
| MnO₂ | 0 | 0 | 0 | 0 | 0 | 0 | 0 | 0 | 0 |
| CuO | 0 | 0 | 0 | 0 | 0.98 | 0.98 | 0.98 | 0.98 | 0.98 |
| Co₃O₄/Fe₂O₃ | 0.16 | 0.05 | 0.05 | 0.06 | 5.00 | 2.38 | 3.33 | 2.27 | 4.55 |
| (SiO₂ + Al₂O₃ + B₂O₃)/ | 4.31 | 3.80 | 3.61 | 3.70 | 4.39 | 4.39 | 4.39 | 4.24 | 5.18 |
| (ΣR′₂O + CaO + SrO + BaO + | | | | | | | | | |
| Co₃O₄ + Fe₂O₃) | | | | | | | | | |
| Absorption coefficient [mm⁻¹] | 0.164 | 0.329 | 0.335 | 0.339 | 0.346 | 0.342 | 0.347 | 0.258 | 0.402 |
| (Minimum value at wavelengths of | | | | | | | | | |
| 380 nm to 780 nm) | | | | | | | | | |
| Relative value of absorption | 0.791 | 0.790 | 0.799 | 0.804 | 0.783 | 0.792 | 0.806 | 0.780 | 0.776 |
| coefficient (@550 nm/@600 nm) | | | | | | | | | |
| Relative value of absorption | 0.920 | 0.862 | 0.774 | 0.873 | 0.916 | 0.894 | 0.856 | 0.787 | 0.962 |
| coefficient (@450 nm/@600 nm) | | | | | | | | | |
| Plate thickness (mm) | 4.5 | — | — | — | — | — | — | — | — |
| Absorbance | 0.74 | — | — | — | — | — | — | — | — |
| (Minimum value at wavelengths of | | | | | | | | | |
| 380 nm to 780 nm) | | | | | | | | | |

TABLE 6

| | Example | Example | Example | Example | Example | Example | Example | Example | Example |
|---|---|---|---|---|---|---|---|---|---|
| [mol %] | 46 | 47 | 48 | 49 | 50 | 51 | 52 | 53 | 54 |
| SiO₂ | 66.8 | 62.9 | 58.9 | 62.9 | 64.8 | 70.7 | 70.7 | 70.7 | 70.6 |
| Na₂O | 13.8 | 15.7 | 17.7 | 14.8 | 14.7 | 12.4 | 14.3 | 12.4 | 12.4 |
| K₂O | 0 | 0 | 0 | 1.0 | 2.0 | 0.2 | 0.2 | 0.2 | 0.2 |
| MgO | 7.9 | 7.9 | 7.9 | 8.8 | 7.9 | 5.4 | 5.4 | 5.4 | 5.4 |
| CaO | 0 | 0 | 0 | 0 | 0 | 8.5 | 2.6 | 8.4 | 8.4 |
| BaO | 0 | 0 | 0 | 0 | 0 | 0 | 0 | 0 | 0 |
| SrO | 0 | 0 | 0 | 0 | 0 | 0 | 0 | 0 | 0 |
| Al₂O₃ | 9.8 | 11.8 | 13.8 | 10.8 | 8.8 | 1.1 | 5 | 1.1 | 1.1 |
| TiO₂ | 0 | 0 | 0 | 0 | 0 | 0 | 0 | 0 | 0 |
| ZrO₂ | 0 | 0 | 0 | 0 | 0 | 0 | 0 | 0 | 0 |
| CeO₂ | 0 | 0 | 0 | 0 | 0 | 0 | 0 | 0 | 0 |
| CoO (Co₃O₄) | 0.05 | 0.05 | 0.05 | 0.05 | 0.05 | 0.05 | 0.05 | 0.05 | 0.05 |
| Fe₂O₃ | 0.013 | 0.020 | 0.020 | 0.014 | 0.010 | 0.010 | 0.016 | 0.025 | 0.012 |
| Er₂O₃ | 0 | 0 | 0 | 0 | 0 | 0 | 0 | 0 | 0 |
| Nd₂O₃ | 0 | 0 | 0 | 0 | 0 | 0 | 0 | 0 | 0 |
| SO₃ | 0.1 | 0.1 | 0.1 | 0.1 | 0.1 | 0.1 | 0.1 | 0.1 | 0.1 |
| NiO | 0.65 | 0.65 | 0.65 | 0.65 | 0.65 | 0.65 | 0.62 | 0.72 | 0.8 |
| MnO₂ | 0 | 0 | 0 | 0 | 0 | 0 | 0 | 0 | 0 |
| CuO | 0.98 | 0.98 | 0.98 | 0.98 | 0.98 | 0.98 | 0.98 | 0.98 | 0.98 |
| Co₃O₄/Fe₂O₃ | 3.85 | 2.50 | 2.50 | 3.57 | 5.00 | 5.00 | 3.13 | 2.00 | 4.17 |
| (SiO₂ + Al₂O₃ + B₂O₃)/ | 5.55 | 4.73 | 4.10 | 4.66 | 4.40 | 3.39 | 4.41 | 3.41 | 3.41 |
| (ΣR′₂O + CaO + SrO + BaO + | | | | | | | | | |
| Co₃O₄ + Fe₂O₃) | | | | | | | | | |
| Absorption coefficient [mm⁻¹] | — | — | — | — | — | — | — | — | — |
| (Minimum value at wavelengths of | | | | | | | | | |
| 380 nm to 780 nm) | | | | | | | | | |
| Relative value of absorption | — | — | — | — | — | — | — | — | — |
| coefficient (@550 nm/@600 nm) | | | | | | | | | |
| Relative value of absorption | — | — | — | — | — | — | — | — | — |
| coefficient (@450 nm/@600 nm) | | | | | | | | | |
| Plate thickness (mm) | — | — | — | — | — | — | — | — | — |
| Absorbance | — | — | — | — | — | — | — | — | — |
| (Minimum value at wavelengths of | | | | | | | | | |
| 380 nm to 780 nm) | | | | | | | | | |

TABLE 7

| | Exam- | Exam- | Exam- | Exam- | Exam- | Exam- | Exam- | Exam- | Exam- | Exam- | Exam- | Exam- |
|---|---|---|---|---|---|---|---|---|---|---|---|---|
| [mol %] | ple 55 | ple 56 | ple 57 | ple 58 | ple 59 | ple 60 | ple 61 | ple 62 | ple 63 | ple 64 | ple 65 | ple 66 |
| SiO₂ | 70.6 | 70.6 | 70.6 | 67.0 | 71.7 | 71.7 | 71.3 | 71.0 | 72.0 | 61.8 | 62.1 | 63.9 |
| Na₂O | 12.4 | 12.4 | 12.4 | 15.3 | 12.5 | 12.5 | 12.5 | 12.5 | 12.6 | 12.0 | 12.1 | 12.4 |
| K₂O | 0.2 | 0.2 | 0.2 | 0 | 0.2 | 0.2 | 0.2 | 0.2 | 0.2 | 3.9 | 3.8 | 4.0 |
| MgO | 5.4 | 5.4 | 5.4 | 5.1 | 5.5 | 5.5 | 5.5 | 5.4 | 5.5 | 10.1 | 10.1 | 10.4 |
| CaO | 8.4 | 8.1 | 8.1 | 0.1 | 8.6 | 8.6 | 8.5 | 8.2 | 8.6 | 0 | 0 | 0 |
| BaO | 0 | 0 | 0 | 0 | 0 | 0 | 0 | 0 | 0 | 0 | 0 | 0 |
| SrO | 0 | 0 | 0 | 0 | 0 | 0 | 0 | 0 | 0 | 0 | 0 | 0 |
| Al₂O₃ | 1.1 | 1.4 | 1.4 | 10.7 | 1.1 | 1.1 | 1.1 | 1.1 | 1.1 | 7.7 | 7.7 | 8.0 |
| TiO₂ | 0 | 0 | 0 | 0 | 0 | 0 | 0 | 0 | 0 | 0 | 0 | 0 |
| ZrO₂ | 0 | 0 | 0 | 0 | 0 | 0 | 0 | 0 | 0 | 0.5 | 0.5 | 0.5 |
| CeO₂ | 0 | 0 | 0 | 0 | 0 | 0 | 0 | 0 | 0 | 0 | 0 | 0 |
| CoO (Co₃O₄) | 0.05 | 0.05 | 0.05 | 0.05 | 0.021 | 0.021 | 0.021 | 0.03 | 0 | 0.38 | 0 | 0.4 |
| Fe₂O₃ | 0.020 | 0.010 | 0.015 | 0.010 | 0.12 | 0.010 | 0.010 | 0.010 | 0 | 3.2 | 3.2 | 0 |
| Er₂O₃ | 0 | 0 | 0 | 0 | 0 | 0 | 0 | 0 | 0 | 0 | 0 | 0 |
| Nd₂O₃ | 0 | 0 | 0 | 0 | 0 | 0 | 0 | 0 | 0 | 0 | 0 | 0 |
| SO₃ | 0.1 | 0.1 | 0.1 | 0.1 | 0.1 | 0.1 | 0.1 | 0.1 | 0 | 0.38 | 0.38 | 0.39 |
| NiO | 0.87 | 0.8 | 0.79 | 0.64 | 0.22 | 0.34 | 0.34 | 0.40 | 0 | 0 | 0 | 0 |
| MnO₂ | 0 | 0 | 0 | 0 | 0 | 0 | 0 | 0 | 0 | 0 | 0 | 0 |
| CuO | 0.98 | 0.98 | 0.98 | 0.98 | 0 | 0 | 0.5 | 0.49 | 0 | 0 | 0 | 0 |
| Co₃O₄/Fe₂O₃ | 2.50 | 5.00 | 3.33 | 5.00 | 0.175 | 21 | 21 | 30 | — | 0.12 | — | — |
| (SiO₂ + Al₂O₃ + B₂O₃)/ | 3.41 | 3.47 | 3.47 | 5.03 | 3.40 | 3.41 | 3.41 | 3.44 | 3.42 | 3.57 | 3.65 | 4.28 |
| (ΣR′₂O + CaO + SrO + BaO + | | | | | | | | | | | | |
| Co₃O₄ + Fe₂O₃) | | | | | | | | | | | | |
| Absorption coefficient [mm⁻¹] | — | — | — | — | 0.090 | 0.066 | 0.101 | 0.098 | — | 1.120 | 1.060 | 0.080 |
| (Minimum value at wavelengths of | | | | | | | | | | | | |
| 380 nm to 780 nm) | | | | | | | | | | | | |
| Relative value of absorption | — | — | — | — | 0.785 | 0.863 | 0.797 | 0.802 | — | 0.76 | 1.15 | 0.61 |
| coefficient (@550 nm/@600 nm) | | | | | | | | | | | | |
| Relative value of absorption | — | — | — | — | 0.787 | 0.987 | 0.884 | 0.888 | — | 0.73 | 2.21 | 0.17 |
| coefficient (@450 nm/@600 nm) | | | | | | | | | | | | |
| Plate thickness (mm) | — | — | — | — | — | — | — | — | — | 0.7 | 0.7 | 9.1 |
| Absorbance | — | — | — | — | — | — | — | — | — | 0.78 | 0.74 | 0.73 |
| (Minimum value at wavelengths of | | | | | | | | | | | | |
| 380 nm to 780 nm) | | | | | | | | | | | | |

TABLE 8

| | Example | Example | Example | Example | Example | Example | Example | Example | Example |
|---|---|---|---|---|---|---|---|---|---|
| [mol %] | 67 | 68 | 69 | 70 | 71 | 72 | 73 | 74 | 75 |
| SiO₂ | 71.3 | 71.3 | 71.2 | 70.1 | 63.3 | 70.2 | 70.9 | 70.2 | 63.3 |
| B₂O₃ | 0 | 0 | 0 | 0 | 5.0 | 0 | 0 | 0 | 5.0 |
| Na₂O | 15.7 | 15.7 | 16.6 | 14.6 | 14.7 | 13.6 | 14.6 | 13.6 | 16.7 |
| K₂O | 0.2 | 0.2 | 0.2 | 0.2 | 0 | 0.2 | 0.2 | 0.2 | 0 |
| MgO | 8.5 | 8.5 | 8.5 | 5.5 | 1.5 | 8.2 | 8.5 | 8.2 | 0 |
| CaO | 0 | 0 | 0 | 0 | 0 | 0 | 0 | 0 | 0 |
| Al₂O₃ | 4.1 | 4.1 | 3.1 | 8.1 | 13.7 | 6 | 5.1 | 6 | 13.2 |
| V₂O₅ | 0 | 0 | 0 | 0 | 0 | 0 | 0 | 0 | 0 |
| Co₃O₄ | 0.002 | 0.002 | 0.0008 | 0.006 | 0.056 | 0.065 | 0.003 | 0.064 | 0.062 |
| Fe₂O₃ | 0.01 | 0.005 | 0.005 | 0.15 | 0.015 | 0.99 | 0.02 | 0.99 | 0.012 |
| Er₂O₃ | 0 | 0 | 0 | 0 | 0 | 0 | 0 | 0 | 0 |
| SO₃ | 0.1 | 0.1 | 0.1 | 0.1 | 0.1 | 0.1 | 0.1 | 0.1 | 0.1 |
| NiO | 0.07 | 0.04 | 0.14 | 0.13 | 0.69 | 0.575 | 0.275 | 0.58 | 0.69 |
| MnO₂ | 0 | 0 | 0 | 0 | 0 | 0 | 0 | 0 | 0 |
| CuO | 0.04 | 0.02 | 0.13 | 0.3 | 0.98 | 0 | 0.37 | 0 | 0.98 |
| Co₃O₄/Fe₂O₃ | 0.20 | 0.40 | 0.16 | 0.04 | 3.73 | 0.07 | 0.15 | 0.06 | 5.17 |
| (SiO₂ + Al₂O₃ + B₂O₃)/ | 4.74 | 4.74 | 4.42 | 5.23 | 5.55 | 5.13 | 5.13 | 5.13 | 4.86 |
| (ΣR′₂O + CaO + SrO + BaO + | | | | | | | | | |
| Co₃O₄ + Fe₂O₃) | | | | | | | | | |
| Absorption coefficient [mm⁻¹] | 0.035 | 0.039 | — | — | — | 0.354 | — | — | — |
| (Minimum value at wavelengths of | | | | | | | | | |
| 380 nm to 780 nm) | | | | | | | | | |
| Relative value of absorption | 0.945 | 0.939 | — | — | — | 0.758 | — | — | — |
| coefficient (@550 nm/@600 nm) | | | | | | | | | |
| Relative value of absorption | 1.027 | 1.009 | — | — | — | 0.874 | — | — | — |
| coefficient (@450 nm/@600 nm) | | | | | | | | | |
| Plate thickness (mm) | — | — | — | — | — | — | — | — | — |
| Absorbance | — | — | — | — | — | — | — | — | — |
| (Minimum value at wavelengths of | | | | | | | | | |
| 380 nm to 780 nm) | | | | | | | | | |

TABLE 9

| | Example | Example | Example | Example | Example | Example | Example | Example | Example |
|---|---|---|---|---|---|---|---|---|---|
| [mol %] | 76 | 77 | 78 | 79 | 80 | 81 | 82 | 83 | 84 |
| SiO₂ | 71.2 | 71.4 | 69.4 | 71.58 | 71.58 | 71.61 | 71.5 | 71.5 | 71.1 |
| B₂O₃ | 0 | 0 | 0 | 0 | 0 | 0 | 0 | 0 | 0 |
| Na₂O | 16.6 | 14.5 | 16.5 | 12.5 | 12.5 | 16.5 | 12.5 | 12.5 | 15.4 |
| K₂O | 0.2 | 0.2 | 0.2 | 0.2 | 0.2 | 0.2 | 0.2 | 0.2 | 0.2 |
| MgO | 8.5 | 9.4 | 9.4 | 5.5 | 5.5 | 5.5 | 5.5 | 5.5 | 5.4 |
| CaO | 0 | 0 | 0 | 8.5 | 8.5 | 0.6 | 8.5 | 8.5 | 2.6 |
| Al₂O₃ | 3.1 | 3.1 | 3.1 | 1.1 | 1.1 | 5.1 | 1.1 | 1.1 | 4.1 |
| V₂O₅ | 0 | 0 | 0 | 0 | 0.25 | 0 | 0 | 0 | 0 |
| Co₃O₄ | 0.0018 | 0.01 | 0.007 | 0.021 | 0.021 | 0.021 | 0.021 | 0.021 | 0.021 |
| Fe₂O₃ | 0.01 | 0.005 | 0.02 | 0.25 | 0.007 | 0.008 | 0.005 | 0.005 | 0.010 |
| Er₂O₃ | 0 | 0 | 0 | 0 | 0 | 0 | 0 | 0.2 | 0 |
| SO₃ | 0.1 | 0.1 | 0 | 0.1 | 0.1 | 0.1 | 0.1 | 0.1 | 0.1 |
| NiO | 0.14 | 0.55 | 0.55 | 0.22 | 0.22 | 0.22 | 0.22 | 0.22 | 0.35 |
| MnO₂ | 0 | 0 | 0 | 0 | 0 | 0 | 0.1 | 0 | 0 |
| CuO | 0.13 | 0.74 | 0.74 | 0 | 0 | 0.2 | 0.20 | 0.20 | 0.74 |
| Co₃O₄/Fe₂O₃ | 0.18 | 2.00 | 0.35 | 0.08 | 2.98 | 2.61 | 4.17 | 4.17 | 2.07 |
| (SiO₂ + Al₂O₃ + B₂O₃)/ | 4.42 | 5.06 | 4.33 | 3.37 | 3.41 | 4.42 | 3.41 | 3.41 | 4.13 |
| (ΣR′₂O + CaO + SrO + BaO + | | | | | | | | | |
| Co₃O₄ + Fe₂O₃) | | | | | | | | | |
| Absorption coefficient [mm⁻¹] | 0.040 | — | 0.472 | — | — | — | 0.070 | 0.086 | 0.119 |
| (Minimum value at wavelengths of | | | | | | | | | |
| 380 nm to 780 nm) | | | | | | | | | |
| Relative value of absorption | 0.991 | — | 0.797 | — | — | — | 0.751 | 0.753 | 0.779 |
| coefficient (@550 nm/@600 nm) | | | | | | | | | |
| Relative value of absorption | 1.203 | — | 0.912 | — | — | — | 0.747 | 0.762 | 0.735 |
| coefficient (@450 nm/@600 nm) | | | | | | | | | |
| Plate thickness (mm) | — | — | — | — | — | — | — | — | — |
| Absorbance | — | — | — | — | — | — | — | — | — |
| (Minimum value at wavelengths of | | | | | | | | | |
| 380 nm to 780 nm) | | | | | | | | | |

TABLE 10

| | Example | Example | Example | Example | Example | Example | Example |
|---|---|---|---|---|---|---|---|
| [mol %] | 85 | 86 | 87 | 88 | 89 | 90 | 91 |
| SiO₂ | 71.2 | 69.4 | 70.8 | 70.9 | 64.0 | 72.3 | 71.3 |
| B₂O₃ | 0 | 0 | 0 | 0 | 5.1 | 0 | 0 |
| Na₂O | 17.4 | 13.5 | 14.6 | 14.6 | 13.9 | 15.7 | 15.7 |
| K₂O | 0.2 | 0.2 | 0.2 | 0.2 | 0 | 0.2 | 0.2 |
| MgO | 4.4 | 11.4 | 8.5 | 8.5 | 2.3 | 8.5 | 8.5 |
| CaO | 0.6 | 0 | 0 | 0 | 0 | 0 | 0 |
| Al₂O₃ | 5.0 | 4.1 | 5.1 | 5.1 | 14.3 | 3.1 | 4.1 |
| V₂O₅ | 0 | 0 | 0 | 0 | 0 | 0 | 0 |
| Co₃O₄ | 0.008 | 0.012 | 0.0035 | 0.0035 | 0.0017 | 0.0029 | 0.0026 |
| Fe₂O₃ | 0.49 | 0.008 | 0.20 | 0.15 | 0.005 | 0.010 | 0.006 |
| Er₂O₃ | 0 | 0 | 0 | 0 | 0 | 0 | 0 |
| SO₃ | 0.1 | 0.1 | 0.1 | 0.1 | 0.1 | 0.1 | 0.1 |
| NiO | 0.54 | 0.55 | 0.17 | 0.07 | 0.14 | 0.04 | 0.07 |
| MnO₂ | 0 | 0 | 0 | 0 | 0 | 0 | 0 |
| CuO | 0 | 0.74 | 0.37 | 0.35 | 0.13 | 0.02 | 0.04 |
| Co₃O₄/Fe₂O₃ | 0.02 | 1.49 | 0.02 | 0.02 | 0.35 | 0.29 | 0.44 |
| (SiO₂ + Al₂O₃ + B₂O₃)/ | 4.08 | 5.36 | 5.07 | 5.09 | 5.99 | 4.75 | 4.75 |
| (ΣR′₂O + CaO + SrO + BaO + | | | | | | | |
| Co₃O₄+ Fe₂O₃) | | | | | | | |
| Absorption coefficient [mm⁻¹] | 0.170 | 0.186 | 0.115 | 0.097 | — | — | 0.049 |
| (Minimum value at wavelengths of | | | | | | | |
| 380 nm to 780 nm) | | | | | | | |
| Relative value of absorption | 1.037 | 0.925 | 0.993 | 0.841 | — | — | 0.918 |
| coefficient (@550 nm/@600 nm) | | | | | | | |
| Relative value of absorption | 1.233 | 1.403 | 1.358 | 0.973 | — | — | 0.960 |
| coefficient (@450 nm/@600 nm) | | | | | | | |
| Plate thickness (mm) | — | — | — | — | — | — | — |
| Absorbance | — | — | — | — | — | — | — |
| (Minimum value at wavelengths of | | | | | | | |
| 380 nm to 780 nm) | | | | | | | |

In Tables 1 to 10, ΣR′₂O represents “Na₂O+K₂O+Li₂O”.

The absorption coefficient was obtained by the following method. The thickness t of the plate-shaped glass, whose both surfaces were mirror polished, was measured with a vernier caliper. The spectral transmittance T of this glass was measured using an ultraviolet, visible, and near-infrared spectrophotometer (V-570 made by JASCO Corporation). The absorption coefficient β was calculated using a relational expression T=10_{-βt}.
Then, the minimum value of the absorption coefficient at wavelengths of 380 nm to 780 nm was obtained. Further, from the obtained absorption coefficient, the relative values of absorption coefficients (an absorption coefficient at a wavelength of 550 nm/an absorption coefficient at a wavelength of 600 nm and an absorption coefficient at a wavelength of 450 nm/an absorption coefficient at a wavelength of 600 nm) were calculated. Further, the absorbance A was calculated using a relational expression A=−log₁₀ T.

From the evaluation result of the absorption coefficient, in the glasses of Examples 1 to 37 as working examples, the minimum value of the absorption coefficient at wavelengths of 380 nm to 780 nm is 1 min⁻¹ or more, or the minimum value of the absorbance at wavelengths of 380 nm to 780 nm is 0.7 or more, from which it can be seen that a certain degree or more of light of a wavelength in the visible range is absorbed. By using these glasses for the housing of an electronic device, a high light blocking effect can be obtained.

Further, from the above evaluation result of the absorption coefficient, in part of glasses of Examples 1 to 62 and Examples 67 to 91 containing 0.005% to 3% of Fe₂O₃, 0.01% to 0.2% of Co₃O₄, and 0.05% to 1% of NiO, or containing 0.005% to 3% of Fe₂O₃, 0.0005% or more and less than 0.01% of Co₃O₄, and 0.01% to 1% of NiO as coloring components, each relative value of the absorption coefficients (the absorption coefficient at a wavelength of 450 nm/the absorption coefficient at a wavelength of 600 nm and the absorption coefficient at a wavelength of 550 nm/the absorption coefficient at a wavelength of 600 nm) is within the range of 0.7 to 1.2, from which it can be seen that it is a glass which averagely absorbs light in the visible range. Accordingly, for example, a good gray color tone can be obtained, which is different from brownish gray and bluish gray.

Further, regarding part of glasses of Examples 1 to 91 illustrated in Table 1 to Table 10, the difference (Δa*) between chromaticity a* of reflected light by a D65 light source and chromaticity a* of reflected light by an F2 light source in an L*a*b* color system standardized by CIE and the difference (Δb*) between chromaticity b* of reflected light by the D65 light source and chromaticity b* of reflected light by the F2 light source in the L*a*b* color system were measured. Further, also regarding glasses after chemical strengthening of part of glasses of Examples 1 to 91, Δa*, Δb* were measured similarly to the above. Results are illustrated in Tables 11 to 20. Note that in Tables 15 to 20, ones described with “-” and ones with no data indicate that these were not measured.

TABLE 11

| | | | Example | Example | Example | Example | Example | Example | Example | Example |
|---|---|---|---|---|---|---|---|---|---|---|
| | | | 4 | 7 | 8 | 9 | 10 | 11 | 12 | 13 |
| Before | Reflection | L* | 29.03 | 28.30 | 27.04 | 27.53 | 29.52 | 30.01 | 26.54 | 28.87 |
| chemical | measurement using | a* | −0.01 | 3.11 | 2.39 | −1.56 | −2.95 | −2.81 | 1.43 | −2.00 |
| strengthening | D65 light source . . . (1) | b* | 0.18 | −9.14 | −4.62 | 0.89 | −0.21 | −2.73 | −7.24 | −2.59 |
| | Reflection | L* | 29.17 | 28.18 | 27.05 | 27.62 | 29.56 | 29.95 | 26.31 | 28.82 |
| | measurement using F2 | a* | −1.51 | 0.55 | 0.33 | −2.06 | −3.42 | −3.46 | 0.36 | −2.68 |
| | light source . . . (2) | b* | 0.50 | −9.71 | −4.55 | 1.06 | −0.20 | −3.00 | −8.18 | −2.88 |
| | (1) − (2) | ΔL* | −0.14 | 0.12 | 0.00 | −0.09 | −0.04 | 0.06 | 0.23 | 0.05 |
| | | Δa* | 1.50 | 2.56 | 2.06 | 0.50 | 0.47 | 0.65 | 1.07 | 0.69 |
| | | Δb* | −0.32 | 0.57 | −0.07 | −0.17 | −0.02 | 0.27 | 0.93 | 0.28 |

TABLE 12

| | | | Example | Example | Example | Example | Example | Example | Example | Example |
|---|---|---|---|---|---|---|---|---|---|---|
| | | | 14 | 15 | 16 | 17 | 19 | 20 | 22 | 23 |
| Before | Reflection | L* | 26.14 | 26.47 | 25.21 | 25.62 | 27.50 | 25.98 | 25.42 | 25.12 |
| chemical | measurement using | a* | 0.52 | 0.92 | 1.32 | 2.21 | −3.37 | −0.23 | 3.39 | 1.05 |
| strengthening | D65 light source . . . (1) | b* | −3.58 | −3.02 | −5.92 | −7.81 | 0.89 | −2.16 | −8.09 | −5.16 |
| | Reflection | L* | 26.11 | 26.51 | 25.04 | 25.43 | 27.49 | 25.97 | 25.30 | 24.97 |
| | measurement using F2 | a* | −0.34 | −0.40 | 0.59 | 1.06 | −2.87 | −0.82 | 1.72 | 0.47 |
| | light source . . . (2) | b* | −3.60 | −2.81 | −6.53 | −8.54 | 0.94 | −0.29 | −8.54 | −5.71 |
| | (1) − (2) | ΔL* | 0.03 | −0.04 | 0.17 | 0.19 | 0.01 | 0.01 | 0.12 | 0.15 |
| | | Δa* | 0.86 | 1.32 | 0.73 | 1.15 | −0.50 | 0.59 | 1.67 | 0.58 |
| | | Δb* | 0.02 | −0.21 | 0.61 | 0.72 | −0.04 | −0.07 | 0.45 | 0.55 |

TABLE 13

| | | | Example | Example | Example | Example | Example | Example | Example | Example |
|---|---|---|---|---|---|---|---|---|---|---|
| | | | 24 | 25 | 26 | 27 | 28 | 29 | 30 | 31 |
| Before | Reflection | L* | 26.25 | 26.53 | 29.03 | 27.72 | 26.66 | 29.21 | 28.79 | 28.80 |
| chemical | measurement using | a* | 0.27 | 0.54 | −0.01 | 1.12 | 1.59 | −0.26 | −2.42 | −2.31 |
| strengthening | D65 light source . . . (1) | b* | −3.05 | −3.47 | 0.18 | −1.91 | −2.70 | −0.41 | −1.39 | −1.35 |
| | Reflection | L* | 26.65 | 26.53 | 29.17 | 27.80 | 26.69 | 29.32 | 28.65 | 28.72 |
| | measurement using F2 | a* | −0.58 | −0.41 | −1.51 | −0.63 | −0.14 | −2.77 | −0.39 | −2.95 |
| | light source . . . (2) | b* | −3.03 | −3.47 | 0.50 | −1.66 | −2.48 | −0.28 | −1.68 | −1.58 |
| | (1) − (2) | ΔL* | 0.00 | 0.00 | −0.14 | −0.08 | −0.03 | −0.11 | 0.14 | 0.08 |
| | | Δa* | 0.84 | 0.95 | 1.50 | 1.75 | 1.73 | 0.71 | 0.67 | 0.63 |
| | | Δb* | −0.02 | 0.00 | −0.32 | −0.25 | −0.22 | −0.13 | 0.28 | 0.23 |

TABLE 14

| | | | Example | Example | Example | Example | Example | Example |
|---|---|---|---|---|---|---|---|---|
| | | | 32 | 33 | 34 | 35 | 36 | 37 |
| Before | Reflection | L* | 28.83 | 28.96 | 28.68 | 27.99 | 28.04 | 29.65 |
| chemical | measurement using | a* | −2.14 | −2.35 | −2.01 | −1.80 | −1.85 | 0.92 |
| strengthening | D65 light source . . . (1) | b* | −1.57 | −0.18 | −0.83 | −1.15 | −1.11 | −4.00 |
| | Reflection | L* | 28.79 | 29.02 | 28.72 | 28.00 | 28.05 | 29.71 |
| | measurement using F2 | a* | −2.78 | −2.88 | 2.63 | −2.39 | −2.46 | −0.98 |
| | light source . . . (2) | b* | −1.78 | −0.14 | −0.88 | −1.25 | −1.19 | −4.07 |
| | (1) − (2) | ΔL* | 0.05 | −0.05 | −0.04 | −0.01 | −0.01 | −0.06 |
| | | Δa* | 0.64 | 0.53 | 0.61 | 0.59 | 0.61 | 1.90 |
| | | Δb* | 0.21 | −0.05 | 0.05 | 0.10 | 0.08 | 0.07 |

TABLE 15

| | | | Example | Example | Example | Example | Example | Example | Example | Example |
|---|---|---|---|---|---|---|---|---|---|---|
| | | | 38 | 39 | 40 | 41 | 42 | 43 | 44 | 45 |
| Before | Reflection | L* | — | — | — | — | — | — | — | — |
| chemical | measurement using | a* | −0.2 | 0.63 | 0.36 | 0.32 | 0.77 | 1.47 | 1.73 | −0.25 |
| strengthening | D65 light source . . . (1) | b* | −2.29 | −3.59 | −2.17 | −2.71 | −3.31 | −4.32 | −5.55 | −1.81 |
| | Reflection | L* | 27.17 | 26.25 | 26.33 | 26.45 | 26.29 | 26.04 | 25.75 | 26.74 |
| | measurement using F2 | a* | −0.9 | −0.11 | −0.37 | −0.49 | −0.14 | 0.38 | 0.61 | −1.05 |
| | light source . . . (2) | b* | −2.47 | −3.99 | −2.33 | −2.62 | −3.27 | −4.35 | −5.69 | −1.68 |
| | (1) − (2) | ΔL* | — | — | — | — | — | — | — | — |
| | | Δa* | 0.7 | 0.74 | 0.73 | 0.81 | 0.91 | 1.09 | 1.12 | 0.80 |
| | | Δb* | 0.18 | 0.4 | 0.16 | −0.09 | −0.04 | 0.03 | 0.14 | −0.13 |
| After | Reflection | L* | — | — | — | — | — | — | — | — |
| chemical | measurement using | a* | −0.02 | 1.6 | 0.24 | 0.5 | 0.91 | 1.56 | — | −0.15 |
| strengthening | D65 light source . . . (1) | b* | −2.41 | −5.46 | −2 | −3.02 | −3.61 | −4.48 | — | −2.12 |
| | Reflection | L* | 26.85 | 25.64 | 26.55 | 26.4 | 26.25 | 25.93 | — | 27.03 |
| | measurement using F2 | a* | −0.8 | 0.43 | −0.49 | −0.3 | 0.01 | 0.49 | — | −0.97 |
| | light source . . . (2) | b* | −2.59 | −6.06 | −2.15 | −3.02 | −3.63 | −4.58 | — | −2.06 |
| | (1) − (2) | ΔL* | — | — | — | — | — | — | — | — |
| | | Δa* | 0.78 | 1.17 | 0.73 | 0.80 | 0.90 | 1.07 | — | 0.82 |
| | | Δb* | 0.18 | 0.60 | 0.15 | 0.00 | 0.02 | 0.10 | — | −0.06 |

TABLE 16

| | | | Exam- | Exam- | Exam- | Exam- | Exam- | Exam- | Exam- | Exam- | Exam- |
|---|---|---|---|---|---|---|---|---|---|---|---|
| | | | ple 46 | ple 47 | ple 48 | ple 49 | ple 50 | ple 51 | ple 52 | ple 53 | ple 54 |
| Before | Reflection | L* | — | — | — | — | — | — | — | — | — |
| chemical | measurement using | a* | −1.76 | −1.66 | −1.65 | −1.39 | 1.52 | −0.08 | 2.23 | 0.04 | −0.08 |
| strengthening | D65 light source . . . (1) | b* | 0.74 | 0.71 | 0.19 | −0.10 | −5.09 | −4.70 | −7.19 | −3.28 | −2.08 |
| | Reflection | L* | 27.79 | 27.58 | 28.06 | 27.35 | 25.72 | 26.20 | 25.22 | 25.88 | 25.46 |
| | measurement using F2 | a* | −2.28 | −2.07 | −0.25 | −1.85 | 0.42 | −0.49 | 0.99 | −0.47 | −0.44 |
| | light source . . . (2) | b* | 1.08 | 1.01 | 0.46 | 0.13 | −5.23 | −4.50 | −7.52 | −3.28 | −2.04 |
| | (1) − (2) | ΔL* | — | — | — | — | — | — | — | — | — |
| | | Δa* | 0.52 | 0.41 | 0.40 | 0.46 | 1.10 | 0.41 | 1.24 | 0.51 | 0.36 |
| | | Δb* | −0.34 | −0.30 | −0.27 | −0.23 | 0.14 | −0.20 | 0.33 | 0.00 | −0.04 |
| After | Reflection | L* | — | — | — | — | — | — | — | — | — |
| chemical | measurement using | a* | −1.67 | −1.39 | −1.31 | −0.96 | 1.57 | 0.17 | 2.30 | 0.14 | 0.10 |
| strengthening | D65 light source . . . (1) | b* | 0.40 | 1.91 | −0.27 | 1.35 | −5.52 | −4.69 | −7.45 | −3.64 | −2.34 |
| | Reflection | L* | 28.23 | 26.64 | 28.48 | 23.39 | 25.96 | 27.12 | 25.66 | 26.14 | 25.87 |
| | measurement using F2 | a* | −.19 | −1.95 | −1.84 | −1.79 | 0.43 | −0.38 | 1.09 | −0.36 | −0.31 |
| | light source . . . (2) | b* | 0.69 | 2.43 | −0.07 | 1.93 | −5.73 | −4.86 | −7.85 | −3.71 | −2.30 |
| | (1) − (2) | ΔL* | — | — | — | — | — | — | — | — | — |
| | | Δa* | 0.52 | 0.56 | 0.53 | 0.83 | 1.14 | 0.55 | 1.21 | 0.50 | 0.41 |
| | | Δb* | −0.29 | −0.52 | −0.20 | −0.58 | 0.21 | 0.17 | 0.40 | 0.07 | −0.04 |

TABLE 17

| | | | Example | Example | Example | Example | Example | Example | Example | Example |
|---|---|---|---|---|---|---|---|---|---|---|
| | | | 55 | 56 | 57 | 58 | 59 | 60 | 61 | 62 |
| Before | Reflection | L* | — | — | — | 25.10 | 48.25 | 43.23 | 41.71 | 37.04 |
| chemical | measurement using | a* | −0.01 | −0.20 | −0.19 | −0.39 | −1.70 | −0.47 | −5.44 | −3.81 |
| strengthening | D65 light source . . . (1) | b* | −1.69 | −2.08 | −2.15 | −0.35 | −8.74 | −2.56 | −4.79 | −4.77 |
| | Reflection | L* | 25.32 | 25.44 | 25.67 | 25.09 | 47.80 | 43.14 | 41.35 | 36.75 |
| | measurement using F2 | a* | −0.31 | −0.53 | −0.54 | −0.47 | −3.19 | −2.30 | −5.26 | −4.12 |
| | light source . . . (2) | b* | −1.65 | −2.03 | −2.09 | −0.41 | −9.88 | −2.75 | −5.37 | −5.14 |
| | (1) − (2) | ΔL* | — | — | — | 0.01 | 0.45 | 0.09 | 0.36 | 0.29 |
| | | Δa* | 0.30 | 0.33 | 0.35 | 0.08 | 1.49 | 1.83 | −0.18 | 0.31 |
| | | Δb* | −0.04 | −0.05 | −0.06 | 0.06 | 1.14 | 0.19 | 0.58 | 0.37 |
| After | Reflection | L* | — | — | — | — | 48.47 | — | — | — |
| chemical | measurement using | a* | 0.14 | 0.00 | 1.6 | — | −1.57 | — | — | — |
| strengthening | D65 light source . . . (1) | b* | −1.84 | −2.28 | −5.46 | — | −9.17 | — | — | — |
| | Reflection | L* | 25.64 | 25.88 | 25.64 | — | 48.01 | — | — | — |
| | measurement using F2 | a* | −0.20 | −0.38 | 0.43 | — | −3.07 | — | — | — |
| | light source . . . (2) | b* | −1.81 | −2.55 | −6.06 | — | −10.37 | — | — | — |
| | (1) − (2) | ΔL* | — | — | — | — | 0.46 | — | — | — |
| | | Δa* | 0.34 | 0.38 | 1.17 | — | 1.50 | — | — | — |
| | | Δb* | −0.03 | 0.27 | 0.60 | — | 1.20 | — | — | — |

TABLE 18

| | | | Example | Example | Example | Example | Example | Example | Example | Example |
|---|---|---|---|---|---|---|---|---|---|---|
| | | | 67 | 68 | 69 | 70 | 71 | 72 | 73 | 74 |
| Before | Reflection | L* | 73.34 | 76.15 | 62.23 | 56.57 | 26.60 | 25.83 | 41.77 | 25.82 |
| chemical | measurement using | a* | 0.10 | 0.22 | 0.63 | 1.49 | −0.15 | 0.29 | 0.63 | 0.33 |
| strengthening | D65 light source . . . (1) | b* | −4.00 | −1.94 | 2.70 | −2.21 | −1.19 | −1.86 | 1.40 | −1.82 |
| | Reflection | L* | 73.29 | 76.21 | 61.72 | 56.87 | 26.66 | 25.83 | 42.33 | 25.82 |
| | measurement using F2 | a* | 0.72 | −0.13 | 1.38 | −0.17 | −0.87 | −0.51 | −0.34 | −0.51 |
| | light source . . . (2) | b* | −2.78 | −3.06 | 2.97 | −3.14 | −1.14 | −1.90 | 1.73 | −1.84 |
| | (1) − (2) | ΔL* | 0.05 | −0.06 | 0.51 | −0.30 | −0.06 | 0.00 | −0.56 | 0.00 |
| | | Δa* | −0.62 | 0.35 | −0.75 | 1.66 | 0.72 | 0.80 | 0.97 | 0.84 |
| | | Δb* | −1.22 | 1.12 | −0.27 | 0.93 | −0.05 | 0.04 | −0.33 | 0.02 |
| After | Reflection | L* | — | — | — | 56.32 | 28.47 | 26.16 | 41.65 | 26.04 |
| chemical | measurement using | a* | — | — | — | 1.42 | −0.64 | 0.40 | 0.82 | 0.31 |
| strengthening | D65 light source . . . (1) | b* | — | — | — | −2.73 | −1.87 | −2.02 | 0.73 | −1.94 |
| | Reflection | L* | — | — | — | 56.60 | 28.44 | 26.15 | 42.18 | 26.05 |
| | measurement using F2 | a* | — | — | — | −0.20 | −1.04 | −0.41 | −0.18 | −0.49 |
| | light source . . . (2) | b* | — | — | — | −3.72 | −2.00 | −2.10 | 0.98 | −1.98 |
| | (1) − (2) | ΔL* | — | — | — | −0.28 | 0.03 | 0.01 | −0.53 | −0.01 |
| | | Δa* | — | — | — | 1.62 | 0.40 | 0.81 | 1.00 | 0.80 |
| | | Δb* | — | — | — | 0.99 | 0.13 | 0.08 | −0.25 | 0.04 |

TABLE 19

| | | | Example | Example | Example | Example | Example | Example | Example | Example |
|---|---|---|---|---|---|---|---|---|---|---|
| | | | 75 | 76 | 77 | 78 | 79 | 80 | 81 | 82 |
| Before | Reflection | L* | 24.95 | 60.39 | 32.30 | 33.21 | 48.85 | 48.29 | 43.11 | 48.10 |
| chemical | measurement using | a* | 5.52 | 1.13 | 0.34 | 0.14 | −2.41 | −2.80 | 4.28 | −3.39 |
| strengthening | D65 light source . . . (1) | b* | −10.67 | 1.06 | −0.98 | −0.34 | −8.52 | −6.54 | −23.94 | −11.36 |
| | Reflection | L* | 24.79 | 60.79 | 32.58 | 33.51 | 48.38 | 47.88 | 42.09 | 47.48 |
| | measurement using F2 | a* | 3.32 | 0.35 | −0.67 | −0.68 | −3.60 | −3.94 | 1.82 | −4.16 |
| | light source . . . (2) | b* | −11.57 | 0.54 | −0.51 | 0.20 | −9.64 | −7.48 | −27.65 | −12.93 |
| | (1) − (2) | ΔL* | 0.16 | −0.40 | −0.28 | −0.30 | 0.47 | 0.41 | 1.02 | 0.62 |
| | | Δa* | 2.20 | 0.78 | 1.01 | 0.82 | 1.19 | 1.14 | 2.46 | 0.77 |
| | | Δb* | 0.90 | 0.52 | −0.47 | −0.54 | 1.12 | 0.94 | 3.71 | 1.57 |
| After | Reflection | L* | 25.61 | 60.37 | 32.07 | 32.88 | — | — | — | — |
| chemical | measurement using | a* | 5.20 | 1.05 | 1.01 | 0.53 | — | — | — | — |
| strengthening | D65 light source . . . (1) | b* | −10.11 | 0.98 | −2.23 | −1.38 | — | — | — | — |
| | Reflection | L* | 25.47 | 60.76 | 32.32 | 33.13 | — | — | — | — |
| | measurement using F2 | a* | 3.10 | 0.30 | −0.13 | −0.35 | — | — | — | — |
| | light source . . . (2) | b* | −10.97 | 0.50 | −1.92 | −0.97 | — | — | — | — |
| | (1) − (2) | ΔL* | 0.14 | −0.39 | −0.25 | −0.25 | — | — | — | — |
| | | Δa* | 2.10 | 0.75 | 1.14 | 0.88 | — | — | — | — |
| | | Δb* | 0.86 | 0.48 | −0.31 | −0.41 | — | — | — | — |

TABLE 20

| | | | Exam- | Exam- | Exam- | Exam- | Exam- | Exam- | Exam- | Exam- | Exam- |
|---|---|---|---|---|---|---|---|---|---|---|---|
| | | | ple 83 | ple 84 | ple 85 | ple 86 | ple 87 | ple 88 | ple 89 | ple 90 | ple 91 |
| Before | Reflection | L* | 48.21 | 38.98 | 33.78 | 35.21 | 53.09 | 67.02 | 70.84 | 73.60 | 82.54 |
| chemical | measurement using | a* | −2.73 | −2.39 | 5.20 | −2.20 | 0.54 | −4.69 | 2.18 | −0.64 | −0.16 |
| strengthening | D65 light source . . . (1) | b* | −11.17 | −13.36 | −2.00 | 6.06 | 7.91 | −0.70 | 16.72 | −10.87 | −2.36 |
| | Reflection | L* | 47.73 | 38.30 | 34.07 | 35.77 | 53.83 | 66.99 | 71.87 | 73.06 | 82.48 |
| | measurement using F2 | a* | −3.85 | −2.80 | 2.43 | −2.51 | −0.42 | −3.90 | 1.03 | −1.12 | −0.26 |
| | light source . . . (2) | b* | −12.47 | −15.34 | −1.74 | 7.32 | 8.54 | −1.56 | 18.56 | −13.10 | −3.49 |
| | (1) − (2) | ΔL* | 0.48 | 0.68 | −0.29 | −0.56 | −0.74 | 0.03 | −1.03 | 0.54 | 0.06 |
| | | Δa* | 1.12 | 0.41 | 2.77 | 0.31 | 0.96 | −0.79 | 1.15 | 0.48 | 0.10 |
| | | Δb* | 1.30 | 1.98 | −0.26 | −1.26 | −0.63 | 0.86 | −1.84 | 2.23 | 1.13 |
| After | Reflection | L* | — | — | — | — | — | — | — | — | — |
| chemical | measurement using | a* | — | — | — | — | — | — | — | — | — |
| strengthening | D65 light source . . . (1) | b* | — | — | — | — | — | — | — | — | — |
| | Reflection | L* | — | — | — | — | — | — | — | — | — |
| | measurement using F2 | a* | — | — | — | — | — | — | — | — | — |
| | light source . . . (2) | b* | — | — | — | — | — | — | — | — | — |
| | (1) − (2) | ΔL* | — | — | — | — | — | — | — | — | — |
| | | Δa* | — | — | — | — | — | — | — | — | — |
| | | Δb* | — | — | — | — | — | — | — | — | — |

Δa* and Δb* were obtained by the following method. A spectro-colorimeter (Colori7 made by X-Rite, Inc.) was used to measure reflected chromaticity of each of the D65 light source and the F2 light source of each glass, and measurement results were used to calculate Δa* and Δb*. Note that on a rear face side (the rear face of a face irradiated with light from the light source) of the glass, a white resin plate was placed to perform measurement.

When the glass for chemical strengthening of the present invention is chemically strengthened, for example, it is carried out as follows. Specifically, these glasses are each immersed for six hours in a KNO₃ molten salt (100%) at approximately 425° C. to chemically strengthen it.

Concretely, the chemical strengthening was performed as follows. Specifically, glasses were prepared in such a manner that 4 mm×4 mm surfaces of part of glasses of Examples 1 to 91 in a shape of 4 mm×4 mm×0.8 mm were mirror finished and other surfaces were #1000 finished. These glasses were immersed for six hours in a molten salt constituted of KNO₃ (99%) and NaNO₃ (1%) at 425° C. to chemically strengthen them. However, the glass of Example 75 was immersed for six hours in a molten salt constituted of KNO₃ (99%) and NaNO₃ (1%) at 400° C. to chemically strengthen it.

As illustrated in Tables 11 to 20, in the glasses of Examples 4, 9 to 17, 19, 20, 22 to 62, 67 to 74, 76 to 80, 82 to 84, 86 to 89, and 91 containing CuO or Fe₂O₃, both Δa* and Δb* are less than 2 in absolute value, and it can be seen that a glass having low metamerism can be obtained.

On the other hand, in the glasses of Examples 7, 8, 75, 81, and 85 having a relatively small content of CuO or Fe₂O₃, the absolute value of Δa* is larger than 2, and the effect of suppressing metamerism could not be obtained sufficiently.
Moreover, as illustrated in Tables 11 to 20, in the glasses of Examples 41 to 57, and 71 containing 0.8% or more of CuO, both Δa* and Δb* of glasses after chemical strengthening are less than 2 in absolute value, and it can be seen that a chemical strengthened glass having low metamerism can be obtained.

Chemical strengthening was performed on the glasses of Examples 8, 14, 20, 22 to 25, 38, 41 to 43, 45 to 56, and 58 among the above-described examples, similarly to the glasses used for measuring reflected chromaticity of the D65 light source and the F2 light source described above.

Surface compressive stress (CS) and the depth of surface compressive stress layer (DOL) of each glass after the chemical strengthening were measured using a surface stress measurement apparatus. Evaluation results are illustrated in Table 21. Note that the surface stress measurement apparatus is an apparatus utilizing the fact that the surface compressive stress layer formed on a glass surface differs in refractive index from other glass portions where the surface compressive stress layer does not exist, thereby exhibiting an optical waveguide effect. Further, in the surface stress measurement apparatus, an LED whose central wavelength is 795 nm was used as a light source to perform the measurement.

TABLE 21

| | E8 | E14 | E20 | E22 | E23 | E24 | E25 | E38 | E41 | E42 | E43 | E45 |
|---|---|---|---|---|---|---|---|---|---|---|---|---|
| Surface | 794 | 784 | 853 | 817 | 797 | 767 | 774 | 607 | 692 | 535 | 396 | 1115 |
| compressive | | | | | | | | | | | | |
| stress | | | | | | | | | | | | |
| CS[MPa] | | | | | | | | | | | | |
| Depth of | 42 | 36 | 33 | 41 | 34 | 36 | 39 | 15 | 46 | 54 | 44 | 34.5 |
| surface | | | | | | | | | | | | |
| compressive | | | | | | | | | | | | |
| stress layer | | | | | | | | | | | | |
| DOL[μm] | | | | | | | | | | | | |
| | E46 | E47 | E48 | E49 | E50 | E51 | E52 | E53 | E54 | E55 | E56 | E58 |
| Surface | 1085 | 1202 | 1293 | 1107 | 940 | 720 | 700 | 745 | 757 | 742 | 772 | 1113 |
| compressive | | | | | | | | | | | | |
| stress | | | | | | | | | | | | |
| CS[MPa] | | | | | | | | | | | | |
| Depth of | 28.7 | 29 | 31 | 30.5 | 36.9 | 7.8 | 23.5 | 8 | 7.4 | 7 | 7.3 | 35 |
| surface | | | | | | | | | | | | |
| compressive | | | | | | | | | | | | |
| stress layer | | | | | | | | | | | | |
| DOL[μm] | | | | | | | | | | | | |

E8 to E58 = Example 8 to Example 58

As illustrated in Table 21, in glasses of Examples 8, 14, 20, 22 to 25, 38, 41 to 43, 45 to 56, and 58, under the chemical strengthening condition, a sufficient surface compressive stress and depth of surface compressive stress layer of 5 μm or more were obtained. As a result, it is conceivable that the glasses of the working examples can obtain a necessary and sufficient strength improving effect by the chemical strengthening. Further, the depth of the surface compressive stress layer of each glass of Examples 8, 14, 20, 22 to 25, 41 to 43, 45, 50, and 58 as working examples was 33 μm or more, from which it is presumed that a glass having high strength after the chemical strengthening can be obtained.

In order to confirm color change characteristics due to long term use of the glasses, the following evaluation test was performed. Samples obtained in such a manner that the glass samples of Example 37 were cut into 30 mm square plate shape and both surfaces thereof were optically polished to a predetermined thickness, were disposed at a position of 15 cm from a mercury lamp (H-400P) and irradiated with ultraviolet rays for 100 hours. The spectral transmittance of each sample before and after this light irradiation was measured using an ultraviolet, visible, and near-infrared spectrophotometer (V-570 made by JASCO Corporation), and the absorption coefficient was calculated from the obtained spectral transmittance by using the above-described relational expression. Then, from the absorption coefficient of each sample before and after the light irradiation, variation amounts ΔT (550/600) and ΔT (450/600) of relative values of absorption coefficients represented by following expressions (1) and (2) were calculated. Evaluation results are illustrated in Table 22.

ΔT(550/600)(%)=[{A(550/600)−B(550/600)}/A(550/600)]×100 (1)

ΔT(450/600)(%)=[{A(450/600)−B(450/600)}/A(450/600)]×100 (2)

(In the above expression (1), A(550/600) is a relative value of an absorption coefficient at a wavelength of 550 nm to an absorption coefficient at a wavelength of 600 nm, as calculated from a spectral transmittance curve of the glass after being irradiated with light of a 400 W high-pressure mercury lamp for 100 hours, and B(550/600) is a relative value of an absorption coefficient at a wavelength of 550 nm to an absorption coefficient at a wavelength of 600 nm, as calculated from a spectral transmittance curve of the glass before the light irradiation. In the above expression (2), A(450/600) is a relative value of an absorption coefficient at a wavelength of 450 nm to an absorption coefficient at a wavelength of 600 nm, as calculated from a spectral transmittance curve of the glass after irradiation with light of a 400 W high-pressure mercury lamp for 100 hours, and B(450/600) is a relative value of an absorption coefficient at a wavelength of 450 nm to an absorption coefficient at a wavelength of 600 nm, as calculated from a spectral transmittance curve of the glass before the light irradiation.)

TABLE 22

| | Example 37 | |
|---|---|---|
| | Plate thickness: 0.780 mm | |
| | Before light | After light |
| | irradiation | irradiation |
| (1): Absorption coefficient at wavelength | 1.100 | 1.108 |
| of 600 nm | | |
| (2): Absorption coefficient at wavelength | 0.873 | 0.877 |
| of 550 nm | | |
| (3): Absorption coefficient at wavelength | 1.007 | 1.014 |
| of 450 nm | | |
| Absolute value of absorption coefficient | 0.793 | 0.791 |
| (@550 nm/@600 nm)*1 | | |
| Absolute value of absorption coefficient | 0.916 | 0.915 |
| (@450 nm/@600 nm)*2 | | |

| | |
|---|---|
| ΔT(550/600)[%] | −0.30 |
| ΔT(450/600)[%] | −0.07 |

*1Calculated from calculating expression of (2)/(1) based on absorption coefficient at each wavelength
*2Calculated from calculating expression of (3)/(1) based on absorption coefficient at each wavelength

As illustrated in Table 22, in the glass of Example 37, variation amounts ΔT (550/600) and ΔT (450/600) of relative values of absorption coefficients before and after the ultraviolet irradiation are both 5% or less in absolute value, from which it can be seen that there will be no color change in glass due to long term use, and an initial appearance color can be maintained for a long period.

Further, the absorption coefficient at wavelengths of 380 nm to 780 nm was also obtained similarly to the above for the glass after the chemical strengthening, and it was recognized that there was no change from the value before the chemical strengthening in either of them. It was also recognized that there was no change in color tone by visual observation. Thus, the glass for chemical strengthening of the present invention can be used for purposes that require strength by chemical strengthening without impairing a desired color tone. Therefore, the range of application can be extended to purposes which are required to have a decorating function.

In order to confirm radio wave transparency of the glass, the following evaluation test was performed. First, the glass of Example 8 was cut out and processed to have a size 50 mm×50 mm×0.8 mm, and its main surface was polished to be in a mirror state. This glass was measured for a dielectric loss tangent at frequencies of 50 MHz, 500 MHz, 900 MHz, 1.0 GHz by a volumetric method (parallel flat plate method) using an LCR meter and electrodes. Measurement results are illustrated in Table 23. Note that the dielectric constants (e) of the glass at the frequency of 50 MHz was 7.6.

TABLE 23

| | Example 8 |
|---|---|
| Frequency | tanδ |

| | | |
|---|---|---|
| 50 | MHz | 0.006 |
| 500 | MHz | 0.006 |
| 900 | MHz | 0.005 |
| 1.0 | GHz | 0.004 |

As illustrated in Table 23, in the glass of Example 8, the dielectric loss tangent at frequencies in the range of 50 MHz to 1.0 GHz is less than 0.01, and it can be seen that it has favorable radio wave transparency.

Regarding the number of bubbles, to confirm the effect of Fe₂O₃ and Co₃O₄, the glass components and contents other than Fe₂O₃ and Co₃O₄ were assumed to be the same, and the number of bubbles was checked for each one containing both Fe₂O₃ and Co₃O₄, each one containing only Fe₂O₃, and each one containing only Co₃O₄. Note that the glass of Example 65 is one omitting only Co₃O₄ from the glass of Example 64. Further, the glass of Example 66 is one omitting only Fe₂O₃ from the glass of Example 64.

Regarding the number of bubbles, the number of bubbles of an area of 0.6 cm³ was measured at four positions on the aforementioned plate-shaped glass under a high-intensity light source (LA-100T made by Hayashi Watch-works), and a value converted from the average value of measurement values therefrom in unit volume (cm³) was presented.

The number of bubbles is largely affected by a parent composition and a melting temperature of the glass, and hence, as described above, the components and contents other than Fe₂O₃ and Co₃O₄ were assumed to be the same, and comparison of ones at the same melting temperatures was performed. Results are illustrated in Table 24.

TABLE 24

| | Contain | Contain | Contain |
|---|---|---|---|
| | Fe₂O₃, Co₃O₄ | only Fe₂O₃ | only Co₃O₄ |
| The number of bubbles | Example 64 | Example 65 | Example 66 |
| [bubbles/cm³] | | | |
| Melting temperature: | 42 | 65 | 59 |
| 1500° C. | | | |

From these results, the glass of Example 64 containing both Fe₂O₃ and Co₃O₄ had a smaller number of bubbles as compared to the glass of Example 65 containing Fe₂O₃ and not containing Co₃O₄ and the glass of Example 66 containing Co₃O₄ and not containing Fe₂O₃. This supports that coexisting Co₃O₄ and Fe₂O₃ exhibit a defoaming effect at the time of melting of the glass. Specifically, it is conceivable that, since 02 bubbles released when trivalent iron turns to bivalent iron in a high temperature state are absorbed when cobalt oxidizes, the O₂ bubbles are reduced as a result, thereby obtaining the defoaming effect.

The glass of the present invention can be used for decorations of an operating panel of an audiovisual apparatus, office automation apparatus, or the like, an opening/closing door, an operating button/knob of the same product, or the like, or a decorative panel disposed around a rectangular display surface of an image display panel of a digital photo frame, TV, or the like, and for a glass housing for an electronic device, and the like. It can also be used for an automobile interior member, a member of furniture or the like, a building material used outdoors or indoors, or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A glass for chemical strengthening comprising, in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (where R represents Mg, Ca, Sr, Ba, or Zn), 0.01% to 0.2% of Co₃O₄, 0.05% to 1% of NiO, and 0.005% to 3% of Fe₂O₃.

2. The glass for chemical strengthening according to claim 1, comprising, in mole percentage based on following oxides, 55% to 80% of SiO₂, 3% to 16% of Al₂O₃, 0% to 12% of B₂O₃, 5% to 16% of Na₂O, 0% to 15% of K₂O, 0% to 15% of MgO, 0% to 3% of CaO, 0% to 18% of ΣRO (where R represents Mg, Ca, Sr, Ba, or Zn), 0.01% to 0.2% of Co₃O₄, 0.05% to 1% of NiO, and 0.005% to 3% of Fe₂O₃.

3. The glass for chemical strengthening according to claim 1, comprising, in mole percentage based on following oxides, 55% to 80% of SiO₂, 0.25% to 5% of Al₂O₃, 0% to 12% of B₂O₃, 5% to 20% of Na₂O, 0% to 8% of K₂O, 0% to 15% of MgO, 5% to 15% of CaO, 5% to 25% of ΣRO (where R represents Mg, Ca, Sr, Ba, or Zn), 0.01% to 0.2% of Co₃O₄, 0.05% to 1% of NiO, and 0.005% to 3% of Fe₂O₃.

4. A glass for chemical strengthening comprising, in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃.

5. The glass for chemical strengthening according to claim 4, comprising, in mole percentage based on following oxides, 55% to 80% of SiO₂, 3% to 16% of Al₂O₃, 0% to 12% of B₂O₃, 5% to 16% of Na₂O, 0% to 15% of K₂O, 0% to 15% of MgO, 0% to 3% of CaO, 0% to 18% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃.

6. The glass for chemical strengthening according to claim 4, comprising, in mole percentage based on following oxides, 55% to 80% of SiO₂, 0.25% to 5% of Al₂O₃, 0% to 12% of B₂O₃, 5% to 20% of Na₂O, 0% to 8% of K₂O, 0% to 15% of MgO, 5% to 15% of CaO, 5% to 25% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃.

7. The glass for chemical strengthening according to claim 1, comprising 0.005% to 3% of a color correcting component having at least one metal oxide selected from the group consisting of oxides of Ti, Cu, Ce, Er, Nd, Mn, and Se.

8. The glass for chemical strengthening according to claim 1, comprising 0.1% to 1% of TiO₂.

9. The glass for chemical strengthening according to claim 1, comprising 0.05% to 3% of CuO.

10. The glass for chemical strengthening according to claim 7, comprising 0.005% to 2% of a color correcting component having at least one metal oxide selected from the group consisting of oxides of Ce, Er, Nd, Mn, and Se.

11. The glass for chemical strengthening according to claim 1, wherein a content ratio of Co₃O₄/Fe₂O₃ is 0.01 to 0.5.

12. The glass for chemical strengthening according to claim 1, wherein a relative value of an absorption coefficient at a wavelength of 550 nm to an absorption coefficient at a wavelength of 600 nm, as calculated from a spectral transmittance curve of the glass, and a relative value of an absorption coefficient at a wavelength of 450 nm to an absorption coefficient at a wavelength of 600 nm, as calculated from a spectral transmittance curve of the glass are both in a range of 0.7 to 1.2.

13. The glass for chemical strengthening according to claim 1, wherein variation amounts ΔT (550/600) and ΔT (450/600) of relative values of absorption coefficients represented by following expressions (1) and (2) are 5% or less in absolute value:
ΔT(550/600)(%)=[{A(550/600)−B(550/600)}/A(550/600)]×100 (1);
and
ΔT(450/600)(%)=[{A(450/600)−B(450/600)}/A(450/600)]×100 (2)
where in the above expression (1), A(550/600) is a relative value of an absorption coefficient at a wavelength of 550 nm to an absorption coefficient at a wavelength of 600 nm, as calculated from a spectral transmittance curve of the glass after irradiation with light of a 400 W high-pressure mercury lamp for 100 hours, and B(550/600) is a relative value of an absorption coefficient at a wavelength of 550 nm to an absorption coefficient at a wavelength of 600 nm, as calculated from a spectral transmittance curve of the glass before the light irradiation; and in the above expression (2), A(450/600) is a relative value of an absorption coefficient at a wavelength of 450 nm to an absorption coefficient at a wavelength of 600 nm, as calculated from a spectral transmittance curve of the glass after irradiation with light of a 400 W high-pressure mercury lamp for 100 hours, and B(450/600) is a relative value of an absorption coefficient at a wavelength of 450 nm to an absorption coefficient at a wavelength of 600 nm, as calculated from a spectral transmittance curve of the glass before the light irradiation.

14. The glass for chemical strengthening according to claim 1, wherein an absolute value of a difference Δa* between chromaticity a* of reflected light by a D65 light source and chromaticity a* of reflected light by an F2 light source in an L*a*b* color system, which difference is expressed by following expression (I), and an absolute value of a difference Δb* between chromaticity b* of reflected light by the D65 light source and chromaticity b* of reflected light by the F2 light source in the L*a*b* color system, which difference is expressed by following expression (II), are both 2 or less:
Δa*=a* value (D65 light source)−a* value (F2 light source) (I); and
Δb*=b* value (D65 light source)−b* value (F2 light source) (II).

15. A chemical strengthened glass obtained by chemical strengthening the glass for chemical strengthening according to claim 1, wherein a depth of a surface compressive stress layer formed in a surface of the chemical strengthened glass by the chemical strengthening is 5 μm or more, and a surface compressive stress of the surface compressive stress layer is 300 MPa or more.

16. The chemical strengthened glass according to claim 15, wherein an absolute value of a difference Δa* between chromaticity a* of reflected light by a D65 light source and chromaticity a* of reflected light by an F2 light source in an L*a*b* color system, which difference is expressed by following expression (I), and an absolute value of a difference Δb* between chromaticity b* of reflected light by the D65 light source and chromaticity b* of reflected light by the F2 light source in the L*a*b* color system, which difference is expressed by following expression (II), are both 2 or less:
Δa*=a* value (D65 light source)−a* value (F2 light source) (I);
and
Δb*=b* value (D65 light source)−b* value (F2 light source) (II).

17. The glass for chemical strengthening according to claim 4, comprising 0.005% to 3% of a color correcting component having at least one metal oxide selected from the group consisting of oxides of Ti, Cu, Ce, Er, Nd, Mn, and Se.

18. The glass for chemical strengthening according to claim 4, comprising 0.1% to 1% of TiO₂.

19. The glass for chemical strengthening according to claim 4, comprising 0.05% to 3% of CuO.

20. The glass for chemical strengthening according to claim 17, comprising 0.005% to 2% of a color correcting component having at least one metal oxide selected from the group consisting of oxides of Ce, Er, Nd, Mn, and Se.

21. The glass for chemical strengthening according to claim 4, wherein a content ratio of Co₃O₄/Fe₂O₃ is 0.01 to 0.5.

22. The glass for chemical strengthening according to claim 4, wherein a relative value of an absorption coefficient at a wavelength of 550 nm to an absorption coefficient at a wavelength of 600 nm, as calculated from a spectral transmittance curve of the glass, and a relative value of an absorption coefficient at a wavelength of 450 nm to an absorption coefficient at a wavelength of 600 nm, as calculated from a spectral transmittance curve of the glass are both in a range of 0.7 to 1.2.

23. The glass for chemical strengthening according to claim 4, wherein variation amounts ΔT (550/600) and ΔT (450/600) of relative values of absorption coefficients represented by following expressions (1) and (2) are 5% or less in absolute value:
ΔT(550/600)(%)=[{A(550/600)−B(550/600)}/A(550/600)]×100 (1);
and
ΔT(450/600)(%)=[{A(450/600)−B(450/600)}/A(450/600)]×100 (2)
where in the above expression (1), A(550/600) is a relative value of an absorption coefficient at a wavelength of 550 nm to an absorption coefficient at a wavelength of 600 nm, as calculated from a spectral transmittance curve of the glass after irradiation with light of a 400 W high-pressure mercury lamp for 100 hours, and B(550/600) is a relative value of an absorption coefficient at a wavelength of 550 nm to an absorption coefficient at a wavelength of 600 nm, as calculated from a spectral transmittance curve of the glass before the light irradiation; and in the above expression (2), A(450/600) is a relative value of an absorption coefficient at a wavelength of 450 nm to an absorption coefficient at a wavelength of 600 nm, as calculated from a spectral transmittance curve of the glass after irradiation with light of a 400 W high-pressure mercury lamp for 100 hours, and B(450/600) is a relative value of an absorption coefficient at a wavelength of 450 nm to an absorption coefficient at a wavelength of 600 nm, as calculated from a spectral transmittance curve of the glass before the light irradiation.

24. The glass for chemical strengthening according to claim 4, wherein an absolute value of a difference Δa* between chromaticity a* of reflected light by a D65 light source and chromaticity a* of reflected light by an F2 light source in an L*a*b* color system, which difference is expressed by following expression (I), and an absolute value of a difference Δb* between chromaticity b* of reflected light by the D65 light source and chromaticity b* of reflected light by the F2 light source in the L*a*b* color system, which difference is expressed by following expression (II), are both 2 or less:
Δa*=a* value (D65 light source)−a* value (F2 light source) (I);
and
Δb*=b* value (D65 light source)−b* value (F2 light source) (II).

25. A chemical strengthened glass obtained by chemical strengthening the glass for chemical strengthening according to claim 4, wherein a depth of a surface compressive stress layer formed in a surface of the chemical strengthened glass by the chemical strengthening is 5 μm or more, and a surface compressive stress of the surface compressive stress layer is 300 MPa or more.

26. The chemical strengthened glass according to claim 25, wherein an absolute value of a difference Δa* between chromaticity a* of reflected light by a D65 light source and chromaticity a* of reflected light by an F2 light source in an L*a*b* color system, which difference is expressed by following expression (I), and an absolute value of a difference Δb* between chromaticity b* of reflected light by the D65 light source and chromaticity b* of reflected light by the F2 light source in the L*a*b* color system, which difference is expressed by following expression (II), are both 2 or less:
Δa*=a* value (D65 light source)−a* value (F2 light source) (I);
and
Δb*=b* value (D65 light source)−b* value (F2 light source) (II).

27. A manufacturing method of a glass for chemical strengthening, the method comprising blending plural kinds of chemical compound materials to make a glass material, heating and melting the glass material, and thereafter defoaming and cooling the glass material, to thereby manufacture a glass for chemical strengthening comprising, in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (where R represents Mg, Ca, Sr, Ba, or Zn), 0.01% to 0.2% of Co₃O₄, 0.05% to 1% of NiO, and 0.005% to 3% of Fe₂O₃.

28. The manufacturing method of a glass for chemical strengthening according to claim 27, the method comprising blending plural kinds of chemical compound materials to make a glass material, heating and melting the glass material, and thereafter defoaming and cooling the glass material, to thereby manufacture a glass for chemical strengthening comprising, in mole percentage based on following oxides, 55% to 80% of SiO₂, 3% to 16% of Al₂O₃, 0% to 12% of B₂O₃, 5% to 16% of Na₂O, 0% to 15% of K₂O, 0% to 15% of MgO, 0% to 3% of CaO, 0% to 18% of ΣRO (where R represents Mg, Ca, Sr, Ba, or Zn), 0.01% to 0.2% of Co₃O₄, 0.05% to 1% of NiO, and 0.005% to 3% of Fe₂O₃.

29. The manufacturing method of a glass for chemical strengthening according to claim 27, the method comprising blending plural kinds of chemical compound materials to make a glass material, heating and melting the glass material, and thereafter defoaming and cooling the glass material, to thereby manufacture a glass for chemical strengthening comprising, in mole percentage based on following oxides, 55% to 80% of SiO₂, 0.25% to 5% of Al₂O₃, 0% to 12% of B₂O₃, 5% to 20% of Na₂O, 0% to 8% of K₂O, 0% to 15% of MgO, 5% to 15% of CaO, 5% to 25% of ΣRO (where R represents Mg, Ca, Sr, Ba, or Zn), 0.01% to 0.2% of Co₃O₄, 0.05% to 1% of NiO, and 0.005% to 3% of Fe₂O₃.

30. A manufacturing method of a glass for chemical strengthening, the method comprising blending plural kinds of chemical compound materials to make a glass material, heating and melting the glass material, and thereafter defoaming and cooling the glass material, to thereby manufacture a glass for chemical strengthening comprising, in mole percentage based on following oxides, 55% to 80% of SiO₂, 0.25% to 16% of Al₂O₃, 0% to 12% of B₂O₃, 5% to 20% of Na₂O, 0% to 15% of K₂O, 0% to 15% of MgO, 0% to 15% of CaO, 0% to 25% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃.

31. The manufacturing method of a glass for chemical strengthening according to claim 30, the method comprising blending plural kinds of chemical compound materials to make a glass material, heating and melting the glass material, and thereafter defoaming and cooling the glass material, to thereby manufacture a glass for chemical strengthening comprising, in mole percentage based on following oxides, 55% to 80% of SiO₂, 3% to 16% of Al₂O₃, 0% to 12% of B₂O₃, 5% to 16% of Na₂O, 0% to 15% of K₂O, 0% to 15% of MgO, 0% to 3% of CaO, 0% to 18% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃.

32. The manufacturing method of a glass for chemical strengthening according to claim 30, the method comprising blending plural kinds of chemical compound materials to make a glass material, heating and melting the glass material, and thereafter defoaming and cooling the glass material, to thereby manufacture a glass for chemical strengthening comprising, in mole percentage based on following oxides, 55% to 80% of SiO₂, 0.25% to 5% of Al₂O₃, 0% to 12% of B₂O₃, 5% to 20% of Na₂O, 0% to 8% of K₂O, 0% to 15% of MgO, 5% to 15% of CaO, 5% to 25% of ΣRO (where R represents Mg, Ca, Sr, Ba, or Zn), 0.0005% or more and less than 0.01% of Co₃O₄, 0.01% to 1% of NiO, and 0.005% to 3% of Fe₂O₃.
